(19) United States
(12) Patent Application Publication
(10) Pub. No.: US 2015/0264296 A1
(43) Pub. Date: Sep. 17, 2015

(54) SYSTEM AND METHOD FOR SELECTION AND VIEWING OF PROCESSED VIDEO

(71) Applicant: videoNEXT Federal, Inc., Chantilly, VA (US)

(72) Inventor: George DEVAUX, Chantilly, VA (US)

(21) Appl. No.: 14/640,703

(22) Filed: Mar. 6, 2015

Related U.S. Application Data
(60) Provisional application No. 61/951,917, filed on Mar. 12, 2014.
(60) Provisional application No. 61/952,444, filed on Mar. 13, 2014.

(51) Int. Cl. H04N 5/93; H04N 5/77; H04N 7/18; H04N 5/272

(52) U.S. Cl. CPC H04N 5/9305; H04N 5/272; H04N 5/77; H04N 7/18

(57) ABSTRACT

Simultaneously processing video input data from thousands of input streams, in real-time or after the fact, automatically carries out logging of video data, extraction of metadata, derivation of additional metadata from extracted metadata, association of extracted metadata and derived metadata with specific video inputs, and record video data and/or metadata in databases for further analysis or viewing, while maintaining linkage between extracted and derived metadata and the video and/or metadata used in its extraction or derivation. Metadata associated with video data using video and associated metadata from additional video data inputs and/or improved processing methods are improved as such information becomes available for processing.

### CROSS-REFERENCE TO RELATED APPLICATIONS

This application claims the benefit of U.S. Provisional Patent Application Nos. 61/951,917 filed Mar. 12, 2104, and 61/952,444 filed Mar. 13, 2014, incorporated herein by reference.

### STATEMENT REGARDING FEDERALLY SPONSORED RESEARCH OR DEVELOPMENT

None.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright 2013, 2014 VideoNEXT.

### FIELD

The exemplary, illustrative, technology herein relates to systems, software, and methods for video surveillance, video monitoring, enhancement of video metadata, and selective access and management to stored video data.

The technology herein has applications in the areas of video data management, security monitoring, police investigation, intelligence work, and scientific research.

### BACKGROUND

Video data is becoming increasingly necessary for research, security monitoring, intelligence work, police surveillance, manufacturing, and other purposes. These uses generate very large amounts of video data, only a tiny fraction of which will ever be needed for the purposes it was collected in aid of. The remainder consists largely of uninteresting captures of empty scenes, normal activity of little or no interest, or redundant views of repeated activity. There are seldom enough resources available to scan through all of the captured video looking for the few frames that hold useful images. Systems and methods useful to locate the minority of useful frames out of the millions of frames of uninteresting video would be helpful and advantageous. The example non-limiting technology herein fulfills these and other needs.

### BRIEF DESCRIPTION OF THE DRAWINGS

Features and advantages of example non-limiting technology herein will best be understood from the following detailed description of example non-limiting embodiments selected for the purposes of illustration and shown in the accompanying drawings of which:

FIG. 1 depicts a schematic diagram of an exemplary embodiment.

FIG. 2 is a process flowchart depicting an exemplary method for processing and retrieving processed video data.

FIG. 3 is a diagram illustrating an exemplary user interface for retrieval and enhanced viewing of stored video data with exemplary video containing five (5) objects.

FIG. 4 is a diagram illustrating an exemplary user interface for retrieval and enhanced viewing of stored video data showing objects filtered for type.

FIG. 5 is a diagram illustrating an exemplary user interface for retrieval and enhanced viewing of stored video data showing objects filtered for speed.

FIG. 6 is a diagram illustrating an exemplary user interface for retrieval and enhanced viewing of stored video data showing objects selected by location.

FIG. 7 is a flowchart of an exemplary video processing method.

FIG. 8 is an exemplary data schema showing relationships between various types of data and metadata.

FIG. 9 is a diagram of an exemplary Scene or Stream data record.

FIG. 10 is a diagram of an exemplary Metadata Item data record.

FIG. 11 is a diagram of an exemplary VDU data record.

FIG. 12 is a diagram of an exemplary Object data record.

FIG. 13 is a diagram of an exemplary Event data record.

### DETAILED DESCRIPTION

Exemplary embodiments provide systems, methods and computer readable storage media that are capable of simultaneous processing of video input data from thousands of input streams, in real-time or after the fact, to automatically carry out logging of video data, extraction of metadata, derivation of additional metadata from extracted metadata, association of extracted metadata and derived metadata with specific video inputs, and record video data and/or metadata in databases for further analysis or viewing, while maintaining linkage between extracted and derived metadata and the video and/or metadata used in its extraction or derivation. Exemplary embodiments support features for improvement of metadata associated with video data using video and associated metadata from additional video data inputs and/or improved processing methods as they become available for processing. Some exemplary embodiments can also process non-video data, such as audio, radar, lidar, sonar, vibration sensors, switches, pressure sensors, or the like. In at least some of these exemplary embodiments processing of such non-video data can result in improvement of video metadata.

Professional video is often “logged” prior to editing or other uses. Generally speaking, logging is a process in which the video's existence and aspects of its capture are recorded as metadata, the video and its metadata are reviewed, and the locations and nature of particular content and/or segments of interest within the video are indicated so that they can be found again when needed. As the volume of video data rises, it becomes increasingly impractical to do logging manually. The example non-limiting technology herein provides automated means for logging video content is needed that can keep up with the rate of video capture, so that video of interest can be located quickly as the need arises.

To aid in determining what video segments are of interest in a given scenario, automated logging also can involve identification of objects in the video. Automated logging may also include the generation and recording of metadata about the video, the identified objects, and/or about events occurring in the video so that these can be used in searching for relevant video data. For reasons such as limitations on available bandwidth in many scenarios, or scaling problems as more video capture devices are added, an ability to distribute at least a portion of the automated logging processing across a plurality of devices, such as to the video capture device, video transmission devices, and/or a central video repository, is useful Additionally, since the needs for locating video content can not in the general case be predicted completely in advance, the automated logging and lookup means should be flexible. For example, the example non-limiting technology herein provides automated logging that can support new types of metadata, new forms of automatic processing, or new event types both in relation to new video data as well as video data previously acquired.

In many application scenarios, the quality of video data can vary widely, in resolution, contrast, brightness, focus, support for color, color balance, whether there is accompanying audio data, and other factors. When performing object detection, identification, and other analysis processing to extract metadata, lower quality video can result in metadata extraction errors such as failure to detect objects, misidentification of objects, object positions being determined incorrectly, or small object movements being missed. The possibility for such metadata extraction errors results in varying levels of confidence in the metadata associated with video data. Methods for computing the level of confidence that can be placed in the metadata associated with a given video based on factors such as the quality of the video, the number of pixels that make up an object, etc., are known. As additional metadata is derived from processing that uses previously extracted metadata, the derived metadata can also have varying levels of confidence based upon the confidence levels of the metadata used in its derivation and the processing involved. Example non-limiting technology herein maintains connection between derived metadata and the metadata used in its creation, and improvements in the original metadata are propagated to derived metadata. Example non-limiting technologies herein identify, quantify, and record potential errors in metadata extraction, to determine automatically confidence levels in both extracted and derived metadata, and to automatically propagate improvements in existing metadata to any derived metadata based on it, and to cause recalculation of metadata if underlying metadata values change.

Large scale video surveillance systems also pose problems for human monitors when it comes to determination of the best video input to use to obtain the required view of a given location or object. Besides dealing with a large number of video sources to select from, each of which may have variable viewing coverage due to programmed pan, tilt and/or zoom (PTZ) “tours” (a scheduled pattern of pan, tilt, and/or zoom changes), some locations in any given scene may not be visible from a particular viewpoint due to occlusion by fixed objects (e.g., buildings, signs, trees, etc.) or mobile objects (e.g., trucks, busses, people, etc.). Changes in lighting angles throughout the day can also cause variations in shadow patterns that can alter selection of the best video input device for viewing a particular location or object. Example non-limiting technology herein provides automated assistance with the task of selecting the best video input for viewing a given location or object to reduce the workload of human operators and to reduce the time required to locate the best, or even a usable, video input. Delay reduction is provided in some example non-limiting embodiments for real-time monitoring tasks.

Large scale video surveillance systems can also involve video input device tasking conflicts. For example, a given video input device with PTZ capabilities may have a regularly scheduled tour pattern intended to cover a given location. When certain events occur, such as a security or fire alarm being triggered, or a human operator entering a command to view a specific location, such regularly scheduled tours may need to be interrupted. If two events occur in an overlapping period of time, a decision may be needed as to which event the video input device is to cover, if a single view can not cover both. Current systems typically respond to the most recent command, and leave determination of view priority to human operators. Mistakes and delays resulting from reliance on human inputs can result in failure to capture video of a higher priority event in favor of a lower priority event or routine monitoring. Example non-limiting technology herein provides automated means for determining priority for use of video input devices to reduce or eliminate such mistakes and delays as well as to reduce workload for human operators.

Additionally, example non-limiting technology herein provides systems and methods to support flexible large scale capture from a variety of real-time and delayed input sources, both video and, in some exemplary embodiments non-video, automated logging, metadata enhancement and update, and selective retrieval of video so that effective use is made of the increasingly available video data provided by today's mobile and fixed video capture systems.

Example non-limiting technology herein thus provides automated systems and methods for processing video input data, and in some exemplary embodiments non-video data, to record and create metadata related to the origin, characteristics, and content of the video input data, while maintaining linkage between metadata and the video data, non-video data, and/or other metadata used in its extraction or derivation.

Example non-limiting technology herein also provides methods and apparatus for managing the associations between metadata and the video and/or other metadata.

Example non-limiting technology herein further provides an improved method and apparatus for accessing stored and real-time feed video data meeting specified criteria.

Example non-limiting technology herein further provides methods and apparatus that enhances analytic capabilities related to extracting useful information from video input data, and in some exemplary embodiments, non-video data.

One example non-limiting embodiment displays video objects by:
a. Identifying a set of objects in a video sequence, the identifying distinguishing between background objects and non-background objects;
b. Creating a cleared background video or still image format representation of a video scene background that does not contain non-background objects by removing non-background objects from the video sequence;
c. Obtaining a selection of one or more items from the list of non-background objects; and
d. Displaying video, iconic, or graphic representations of the selected one or more non-background objects superimposed over the cleared background video or image.

An example non-limiting method for creating or enhancing metadata for a first video sequence using metadata from a second video sequence comprises:
a. capturing the first video sequence and associated first metadata;
b. capturing a second video sequence and associated second metadata; and
c. if the first and second video sequences are determined to be correlated, modifying the first metadata based at least in part on the second metadata.

An example non-limiting method for creating or enhancing metadata for a video sequence using non-video data comprises:
a. capturing a video sequence and associated first metadata;
b. capturing non-video data;
c. determining that the non-video data relates to the video sequence;
d. using the non-video data to determine at least one characteristic of at least one object of the video sequence; and
e. modifying the metadata for the video sequence based at least in part on the at least one object characteristic determined from the non-video data.

Other example non-limiting features and advantages include:
a. displaying non-background objects in the list using icons associated with the non-background objects.
b. applying and displaying filtering criteria to select each object.
c. displaying attributes of at least some of the non-background objects.
d. the displayed attributes include one or more of type, speed, time span, movement, and action.
e. the display of non-background objects is in relative real-time mode.
f. the display of non-background objects is in overlapped-time mode.
g. creating or enhancing metadata for a first video sequence using metadata from a second video sequence.
h. Maintenance of links between metadata enhanced by use of other metadata, and that other metadata, for use in propagating changes resulting from update of metadata in future. (backtracking)
i. Adjustment of confidence values with changes in metadata.
j. Contagious tracking
k. Other.

In some example non-limiting embodiments, video data can be supplied by real-time camera feeds, by video recording devices with stored data (e.g., camera phones, camcorders, VCRs, DVRs, etc.), and by video storage systems with stored video in various formats (e.g., hard drives, USB Flash drives, SD cards, etc). These or other sources of video data are referred to herein as video input devices. Devices used for initial capture of video data, such as camcorders, dashcams, camera phones, security, traffic, or other types of cameras, are referred to herein as video capture devices. Real-time video feeds typically are supplied by video capture devices at known locations and with known identification of the device supplying the video data, but in some cases the location can be approximate or unknown (e.g., live video from a mobile news van, or a head mounted camera on a soldier in the field). Video input data can vary in the amount and quality of the metadata that accompanies the video data, and in some cases may have to be input manually when video data is supplied to exemplary embodiments. Video data can be stored in the form in which it is supplied, or converted to one or more alternate forms for compatibility, for convenience, to enable processing, for maintenance of quality during processing, or to meet other requirements. Metadata associated with video data can be stored with the video data, separately from it, or both, as well as being stored in a plurality of forms and arrangements as required, whether over time or simultaneously.

Video data can be input as analog or digital video feeds in real-time, or as previously recorded video clips. Video data can, in some cases, include audio data. Video data can, in some cases, include metadata about the video and/or its content, such as time of capture, resolution, aperture, focal length of the lens, zoom level, GPS coordinates of the video input device, direction of aim of the video input device, video device information such as make and model or current configuration, processing performed on the video prior to output from the video input device, etc. Processing of the video data is similar regardless of the form of input, however metadata extracted can vary. For example, a previously recorded video clip will have a fixed length, a start time, and an end time, while a real-time video feed will have an increasing length and an end time of the current time, which is constantly being updated. In some exemplary embodiments there is a capability for controlling video capture devices in real-time, such as altering pan, tilt, zoom, aperture, focus, or spectrum sensitivity (e.g., by inserting or removing filters, employing alternate sensors, etc.) in order to change the characteristics of the video data captured.

Video supplied as a real-time stream of video data is referred to herein as a “video feed”. Video recorded over a fixed length period of time is variously referred to herein as a “video clip”, or “video segment”. The area viewable by a given video camera is referred to herein as a “scene”. A given video camera may or may not view the entirety of its scene at any given time. For example, a camera with pan, tilt, and/or zoom (PTZ) capability will typically view only a portion of the scene it is capable of viewing. The portion of a scene captured by a video input device at a given time is referred to herein as a “view”.

Video data, non-video data, and metadata can be stored in one or more commercially available databases, in proprietary databases, or using other storage methods in exemplary embodiments. Databases with adjustable schemas, or which do not rely on defined schemas, are preferred to support video and metadata needs in a flexible manner. Video data, non-video data, and/or metadata can be stored using diverse schemas and/or storage methods.

To deal with a large number of video input sources, exemplary embodiments can use both parallel processing and distributed processing. By use of a plurality of processing elements, each performing processing for a subset of the video input sources, exemplary embodiments can be scaled to handle any number of video inputs. Processing of a given video feed or clip can be done in a single processing element, or be distributed across a plurality of elements. For example, a portion of the processing can be done in the video capture device, and the remainder done in a central facility. Likewise, the processing performed can be done in a single device, such as a general purpose computer, or be done using a plurality of devices, such as a plurality of general purpose computers, each handling a portion of the processing tasks, by special purpose devices such as FPGAs (Field Programmable Gate Arrays) or ASICs (Application-Specific Integrated Circuits), by combinations of these, or by other processing means known to those with skill in the art.

Processing performed on video inputs can comprise known methods for identification of objects in the video inputs (e.g., people, animals, vehicles, signs, buildings, luggage, roadways, plants, etc.), extraction of metadata about the video itself (e.g., time of capture, location of capture, device used for capture, resolution, data format, etc.), extraction of metadata about objects in the video (e.g., the object's type, size, color, location in the video frame, speed of movement, direction of movement, icons to associate with the object, etc.), and recording of the video and metadata in one or more databases. Metadata extracted or derived can also comprise information about other metadata, such as whether a given item of metadata is recorded (e.g., the time of capture of the video), extracted metadata (e.g., the type of an object, or it's location in the view), or derived metadata (e.g., object speed computed from a succession of extracted object location metadata items over a period of time). Some exemplary embodiments also create and maintain metadata about derived metadata, such as information about the metadata used to derive it. Having information about how metadata was derived enables update of the derived metadata should any of the metadata used in its derivation be altered, thus improving the quality of the derived metadata associated with a video sequence over that available with prior art methods.

Regardless of whether processing is done sequentially or in parallel, or in a localized or a distributed manner, the methods used by exemplary embodiments for extracting and maintaining metadata involve the same process steps. Video feeds and video segments are processed in discrete units, referred to herein as “video data units” (VDU). Depending on the technologies in use, a VDU can be a field of video from an analog NTSC TV signal, a frame of video from an analog NTSC TV signal, a frame of video from an MPEG-4 Part 14 (formally ISO/IEC 14496-14:2003) digital video stream or file, or any other useful dividing point as determined to be proper by those with skill in the art. A VDU is used herein to refer to a quantity of video data that is processed as a discrete unit for purposes of metadata extraction, and is not necessarily related to the format or unit divisions used in the source video, or in any processing or output formats the video might be converted into, nor is metadata extracted or derived from VDUs limited to association with individual VDUs. For example, an NTSC analog TV video signal is sent in fields, each of which contains half the lines of video for a frame of video. A VDU in an exemplary embodiment can be equivalent to a field of video, while in an alternative exemplary embodiment a VDU can be a frame of video, and in yet another alternative exemplary embodiment a VDU can be a pixel-based digital representation of an average of several consecutive frames of NTSC analog TV signal data. An exemplary embodiment can also employ a plurality of definitions for what a VDU consists of, for example as specified in one or more configuration settings, based on the type of video input, or based on the needs or capabilities of the processing system.

Processing of video inputs can be done on a per-VDU basis, with each VDU being input, objects in the VDU identified and a confidence value for the identification recorded, other metadata extracted and recorded with associated confidence values, the VDU metadata being correlated with prior VDUs in the same video segment to identify with a confidence above a threshold those objects common to both or unique to either, and to use the correlation results to derive additional metadata and confidence values for the derived metadata. The VDU is then correlated with selected VDUs of other video segments to identify objects both common and unique with a confidence exceeding a threshold, with the goal of extracting additional metadata based on the correlation results. Linkages between derived metadata and the metadata and/or video data used in its derivation are created and maintained during processing as are confidence values for the metadata. Once metadata has been recorded, additional processing, such as event identification, object behavior and interaction detection, inferred event detection, and user search and use of video can be performed. Should processed VDU metadata be used in correlations with other VDUs, and adjustments to metadata be carried out, linkages between metadata and the metadata used to derive it are used to propagate changes to metadata derivations and/or to confidence levels associated with metadata.

The example non-limiting technology herein also maintains a linkage between the metadata used for derivation of other types of metadata, such as object identification, and the derived metadata. Since metadata extraction can be probabilistic, as shown by the use of confidence values to record the likelihood that it is accurate, any metadata derived using probabilistic metadata is similarly probabilistic. Exemplary embodiments comprise methods for creating and maintaining linkages between derived metadata and the metadata used to derive it, and for using such linkages to adjust the confidence values of derived metadata, should the metadata used to derive it, or confidence value of that metadata, change.

For example, if metadata about the size of an object was used to assist in determining the object's type, and the object's size is later found to have been in error, the confidence value of the object's type metadata can be decreased, and/or the determination of the object's type can be repeated, using updated size metadata. Without a linkage between the object's derived type metadata and the object's size metadata being maintained, the change in the size metadata would not be reflected in the confidence value for the object type or cause the object type to be re-evaluated, thus making the object's metadata less consistent and reliable and therefore less useful for many purposes.

Object identification can be assisted in some known art methods by use of metadata, such as object size, location, shape, behavior, or other characteristics. By associating various object characteristics with object types in a knowledge base (e.g., a set of rules), a potential object type identification can be validated against characteristics for that object type, or the potential list of object types for an identification can be narrowed. For example, if an object has a size of 1 meter, it will not be a car, truck, or building, is unlikely to be an adult human, but might be a dog, a child, or a fire hydrant. By combining a plurality of such tests, the confidence level of an identification of an object can be increased. In some exemplary embodiments, such confidence values are recorded as metadata associated with the video data, and may be used for various purposes, such as selection of video for viewing or for use in enhancement of metadata.

In some cases some useful sources of metadata, such as facial recognition results or vehicle license plates, may not be visible in all scenes. When such indicators of object identity are visible, a high confidence can be placed in object identification results, but when such indicators are not visible, object identification is less certain. As an object with a high identification confidence value is tracked from a first video input to a second video input, and high reliability object identification metadata is not available in the second video input, identification of the object in the second video input as being the same object as was visible in the first video input has a lower confidence value than if such identification features were visible in the second video input. As gaps or occlusions occur in moving to a third or fourth video input, the confidence value can continue to degrade in those later videos. If a view enabling high reliability object identification occurs in a fifth video input, the low confidence value metrics for the second, third and fourth scenes can be adjusted upward. Linkage between the metadata used for object identification in the fifth scene and the adjusted metadata from the second, third, and fourth scenes, can allow the prior scene metadata to be adjusted should the identification of the object in the fifth scene change for any reason. For example, if a car is identified by license plate in a first scene, the confidence value that the specific car has been identified can be very high. If the car exits the first scene, and enters a second scene but with the license plate not visible, for instance due to the angle of view, it may be identified as a car, and if the color, make, model, time between the recording of the two scenes combined with the distance between the video input devices, or other factors match the car from the first scene, the metadata in the second scene may identify it as the same car, but with a lower confidence value due to the lack of license plate visibility. If the car then exits the second scene, and enters a third scene that has some overlap with the second scene, but where in the third scene there is a clear view of the license plate, the car will be identified with a high confidence level in the third scene, but the confidence level for the car's identification in the second scene can also be raised.

In some exemplary embodiments, an additional form of metadata is supported: group membership. Groups are objects associated by type, characteristic, or other metadata matching, such as location, or time seen. For example, objects at the same location, at the same location and the same time, having the same speed, traveling in the same direction, being of the same type, carrying out the same action, etc. Group metadata can be stored with other object metadata, or can be computed as needed, or a combination of stored and computed as needed. Metadata extraction or other processing for objects in some exemplary embodiments can be based on group membership, similarly to that described for type-specific metadata extraction elsewhere herein.

Use of event processing methods enable triggering of actions based on video content. Once video processing has determined the metadata associated with a video segment, the metadata is available for use in event processing. For example, rules can be defined that cause an alert to security personnel when a person is captured on video between 6 pm and 6 am in an area that is supposed to be off limits during those hours. In exemplary embodiments, event processing can be used in a feedback mode to alter video capture or processing based on event rules so as to enhance the metadata (extracted and/or derived) that is associated with the video sequence. For example, in a system configured to do facial recognition only for people who enter an area from a particular direction, the event of an object of type person entering a scene from that direction can trigger an action to determine a camera capable of capturing an image of the person's face, zoom the camera in on the particular object and to then perform facial recognition on the captured image. Once facial recognition has completed, the additional metadata comprising the identity of the person is available for further event processing, such as triggering an alert if the person is on a list of persons of interest, or not on a list of permitted persons, or for use in enhancing other video metadata, such as VDUs from video sequences captured prior to the facial recognition processing. Events can also be generated by input from other types of sensors, such as microphones (e.g., alarms, sirens, explosions, gunshots, crash noises), security alarm sensors, chemical detectors, or pressure switches.

In some situations it can be beneficial to be able to predict the behavior of objects and to use such predictions to enhance metadata. For example, if an object is determined to be a bicycle, a prediction that it will not exceed 45 mph is not unreasonable. Should the object be found later doing 60 mph, the confidence value of the bicycle identification can be lowered, and metadata that was based on that prediction can be altered.

Since both real-time feeds and previously recorded clips are processed and stored as video and associated metadata in one or more databases, searching, viewing, use for event processing, and any other uses are supported for both. Additional VDUs from video clips or video feeds can be added at any time, and if new searches, VDU processing, or other uses of the data are carried out, the new video data can be included.

While processing of video inputs is typically done when the video input is presented to the system, in some cases processing can be delayed or repeated. For example, if the processing capabilities of the system are temporarily exceeded, video data can be stored and processed as resources become available. In some exemplary embodiments, prioritization methods can be employed to cause some video data to be processed ahead of other video data. For example, processing of video data from traffic cameras outside of the area of a riot can be delayed so that video from cameras with views of the riot scene can be processed more quickly. Another case where processing is done at a later time occurs when new processing capabilities are added to the system, and previously processed video is re-processed to gain the benefits of the new capabilities. For example, if better face recognition, new rules useful for identifying object characteristics, or additional scenes covering a given event are added, re-processing stored video or re-performing event checking can be useful.

Metadata is also useful for locating video of interest. Video can be located by time of recording, location where recorded, object, activity, and/or event content, or using any other metadata or combination of metadata, using traditional database lookup methods. Use of confidence values is also supported. For example, a query for video recorded yesterday, at a specific location, that contains a yellow car object identified as a convertible with a certainty above 75% might result in a listing of ten video sequences from three video input devices, such as traffic cameras. Using the metadata for these video sequences, the video can be accessed, and played back. Rather than having to determine which cameras had a view of the specific location during the required time period (not difficult for fixed cameras, but harder if some cameras are mobile, such as police dashboard cameras), and then watching 24 hours of video from each camera looking for yellow convertibles, a user of the system can locate the required clips and view them in a few seconds or minutes.

Metadata can also be used to create reports or video overlays to summarize video content. For example, a scene consisting of a roadway intersection could be overlaid with icons, lines, or other graphics to show traffic counts and patterns in the intersection over a period of time to determine such things as which what percentage of traffic turns left, when rush hour starts and ends, or the types of vehicles using the roadway (e.g., cars, trucks, semi-trailers, motorcycles, and bicycles).

Access to metadata and video can be done using traditional database reporting and query methods as described above, but locating and viewing video can also be done in exemplary embodiments by means that are more user friendly, and that support additional uses of video that are not possible by simply locating and viewing recorded video clips. Exemplary methods and their benefits are described herein.

Display of a plurality of objects can be done in a relative real-time mode in some embodiments when requested. That is, if a first object appeared in the scene at 1:00 pm and left the scene at 1:10 pm, and a second object appeared in the scene at 4:00 pm, and left the scene at 4:20 pm, display at relative real-times would not show them at the same time . . . the first object would leave the cleared background prior to the second object appearing, as actually happened when the video was recorded. Playback of the video for the time between the first object leaving and the second object appearing can optionally be suppressed.

Display of objects can be done in an overlapped time mode in some embodiments when requested. That is, if a first object appeared in the scene at 1:00 pm and left the scene at 1:10 pm, and a second object appeared in the scene at 4:00 pm, and left the scene at 4:20 pm, display in overlapped time mode would show both objects simultaneously. Such a mode is useful for determining whether the displayed objects followed the same path, what the relative speed of movement was, how their interaction with other objects varied or was similar, etc. For example, did two people stop and smell the same flower? Did a car slow in front of the same jewelry store each time it drove by? When there are many objects over time, overlapped time display can make patterns of activity more obvious than if the objects are shown separately at relative real-times.

Single Scene with a Plurality of Viewpoints

In some cases there will be a plurality of video inputs that view a single scene, or portions thereof, from a variety of viewpoints. This can occur, for example, when a plurality of cameras are installed with overlapping fields of view, when cameras are re-pointed to cover an event from a plurality of viewpoints, or when video is supplied by bystanders to an event of interest who happened to be recording at the time it occurred (e.g., the 2013 Boston bombing, a witness to an accident with dashboard camera video, or a news crew recording the event for program use).

The quality of the video may vary widely between video input sources. Some of the video input sources may not supply accurate location metadata, camera setting data, or other useful metadata. Due to transmission path differences, or video data being supplied after the fact, video input sources may not be synchronized, and may have different time resolutions where time data is supplied. To reduce the effects of such variations in the quality and completeness of video inputs on the quality of the stored metadata, correlation can be performed between the metadata of various video inputs that cover some or all of a scene, and the metadata from a first video input can be used to enhance the metadata from additional video inputs that overlap in their scene coverage, and the metadata from the additional video inputs can be used to enhance the metadata of the first video input. For example, where video quality is low it can be problematic to identify objects. If a difficult to identify object in a first video input can be correlated with a clearer view of the same object from a second video input, the identification from the second video input's metadata can be used for the first video input's metadata identification of the same object, thus enhancing the first video input's metadata completeness. Correlation of a first and second video input can be done using camera location and pointing metadata, capture time data, or other metadata to calculate the scene overlap of the two inputs. Alternatively or additionally, correlation can be done by identifying objects in the first video input as being the same objects as in the second video input. In some cases, such as face recognition or license plate reading, this may be possible to do directly, while in other cases the identification may be probabilistic, such as by determining that each video input is showing the same number of objects, of the same types, moving in similar manners. Confidence values can be associated with metadata to indicate the probability that the correlation was good.

Correlation between video inputs can also be used to enhance camera location and pointing metadata. For example, if a first camera is in a known location, but a second camera viewing the same scene is not, the location of the second camera can be computed from the apparent locations of the objects in its view combined with information on the actual object locations as determined by the first camera's view.

Correlation between video inputs can also be used to enhance time-related metadata. For example, if a first video input source has more accurate or precise time-related metadata than a second video input source, and the two video input sources can be synchronized by correlating object movement timing, the time of occurrence of an event (e.g., a gunshot, a traffic light change, etc.) between the two, the time-related metadata of the second video input source can be enhanced by using the time-related metadata of the first video input source. Enhancement can refer to the second video source's metadata including time-related metadata at all, or just that the precision or accuracy of such metadata is improved.

In some cases a given object will be occluded by other objects as it moves through a scene as viewed from a first video input location. Metadata about its location, speed, direction, etc. during such periods of occlusion will be based on assumptions, or missing, unless such metadata can be supplied based on other video inputs with viewpoints where the given object is not occluded. Using metadata from such other video inputs can enable accurate metadata for the first video input even during times when objects are occluded. This can enable display of object location, such as by graphical overlay of an icon, outline, or other such method, on a view of the video from the first video input, and enable useful analysis results that would otherwise be unavailable. In real-time video scenarios, where cameras are being re-pointed to track a particular object, metadata from a second video input can enable tracking to continue during periods of object occlusion, possibly preventing loss of video coverage from the first video input when the object emerges from occlusion.

A Plurality of Scenes with a Plurality of Viewpoints

When there are a plurality of video input sources with non-overlapping areas of coverage (i.e., diverse scenes for at least some of the video inputs), it can be difficult to determine which video inputs are useful for following a target object as it leaves a current scene using existing methods. In some cases with a limited number of video inputs human operators can learn which video inputs to switch to, but in cases with a large number of video inputs, such as a city with thousands of cameras, or when using archived footage that may have come in part from contributed video shot from camera phones or other sources not previously known to operators, selecting the best video to gain the views needed is difficult if not impossible. In real-time scenarios there may not be time for a trial-and-error approach of switching views until one is found with the needed coverage, and the problem becomes worse when the factor of some, but not all, camera views being controllable is added. Operators not only have to know where cameras are located, but also what the extent of their view options are in terms of pan and tilt as well as zoom, and what objects will be occluding what portions of their coverage.

Having a database containing video input device locations, coverage areas, capabilities, and the objects in those coverage areas enables rapid selection of the video input with the best view of any given location. Being able to detect and identify objects in real-time that are in view of each video input simultaneously enables tracking of a given object between scenes, even when there are gaps in coverage. As the object leaves one scene it may enter another, but if there is a gap between scenes, any surrounding scenes will pick up the object as it enters one of them, and operators can be alerted, or their monitors switched to the scene with the object. If the object does not enter another scene, the possible area in which it is located will be known to a precision dependent on the density of scene coverage, which reduces the area needed for searching.

The database of video input device scene coverage capabilities is also useful for determining which video input devices can be re-pointed to provide additional views of a given scene. For example, the field of view of a first video input device might be limited to a section of a parking lot. If an event of interest, such as a car leaving that section, occurs, the car will be lost from view when it leaves the section covered by the first video input device. There may be no other video inputs covering the area the car has moved into, but if a second video input can be commanded to re-point so as to view the area the car has moved into, tracking can continue. Determination of a second video input capable of viewing the required area is enabled by the database, both in terms of locating the car and its direction and speed of movement, as well as determining which alternate video input to use as the second video input.

In some scenarios there can be a conflict between the need to have a given video input device capture a first scene or a second scene. For example, a given video input device can be needed to capture a scene where a security alarm has been activated at the same time that it is needed to capture a scene of a riot. If the two scenes do not overlap, there is a conflict, and a decision is needed as to which of the two scenes will be captured. In embodiments where such scene capture requirements are initiated as responses to events, the event processing system can be designed to incorporate a priority scheme, where each event has an associated unique priority, and the event with the highest priority decides which scene is captured. When no events are active, the video input device's default scene capture behavior is carried out. In alternative embodiments other methods can be used, such as the video input device responding to the most recent scene capture request, or a human operator being requested to decide which scene to capture.

### Other Capabilities

When tracking specific objects, such as for intelligence or law enforcement purposes, it can be useful to know what other objects an object of interest has interacted with. A system capable of identifying and following a given object through a plurality of scenes, and that can automatically identify activities (e.g., stopping, beginning movement, joining with another object, separating from another object, etc.), is capable of automatically detecting at least some interactions between objects. This enables creation of a relationship network between objects, and can result in identification of additional objects of interest; known herein as “contagious tracking” Whether an interaction between objects results in creation of a new object of interest can be determined by human operators who are shown the interaction and queried, or be handled automatically through, for example, a rule-based system that defines the types of interactions, duration of interaction, frequency of interaction, etc. required to create a new object of interest. These and other aspects and advantages will become apparent when the description below is read in conjunction with the accompanying drawings.

### Exemplary System Architecture

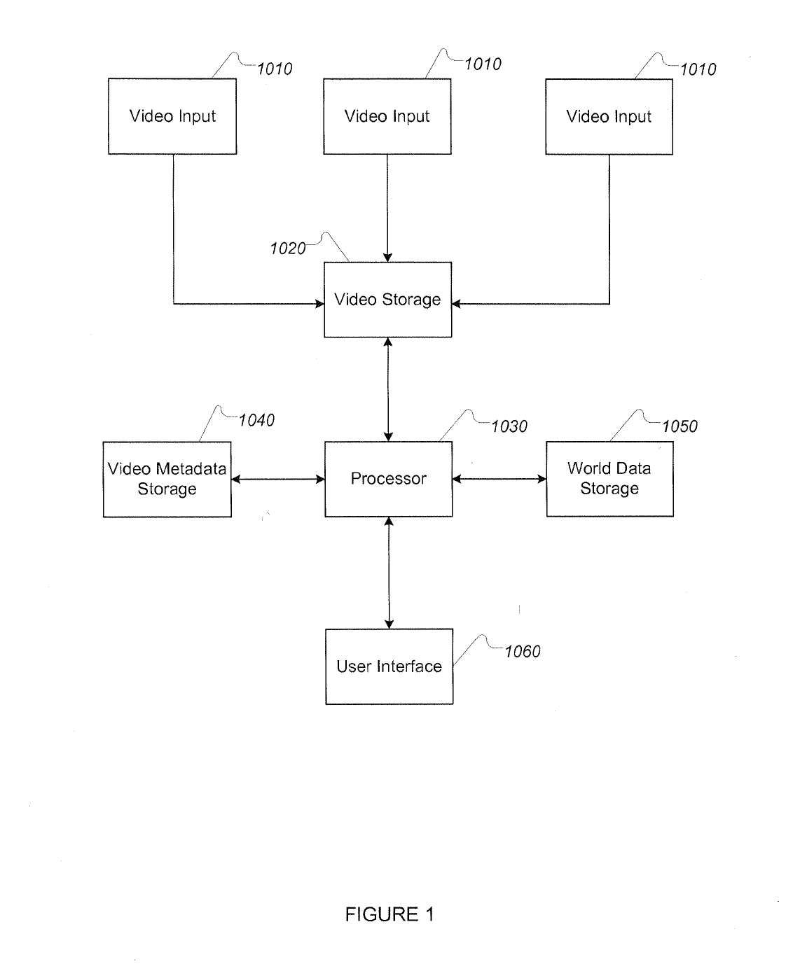

FIG. 1 shows the major components of an exemplary embodiment. These comprise one or more video input devices (1010); a video storage component (1020), such as one or more hard drives, solid state storage device (SSD), network attached storage system (NAS), storage area network (SAN), or other storage system capable of holding video data and providing it in a form usable by a processor arrangement (1030), such as a general purpose computer, special purpose hardware device, or the like; a video metadata storage component for storing and retrieving of video metadata (1040), such as one or more hard drives, DBMSs (DataBase Management Systems), NAS, SSD, SAN, or the like or any combination of these or other components as determined to be proper by those with skill in the art; a world data storage component (1050), such as a hard drive, DBMSs, NAS, SSD, SAN, ROM, or the like or any combination of these or other components as determined to be proper by those with skill in the art; and a user interface component (1060), such as a PC, monitor and keyboard, touch screen, voice input device, pointing device, or any combination of these or other components useful for the purpose. The video, metadata, and world data storage components can be combined if desired, and share a single hardware device or set of devices and/or retrieval system. The processor can be a single device, or a plurality of devices, such as a parallel processing system, distributed processing system, or other system useful to accomplish the processing tasks required.

In some example embodiments, the processing arrangement (1030) executes instructions stored in non-transitory computer readable storage devices such as random access memory, read only memory, flash memory, magnetic memory or any other suitable arrangement.

The video storage component (1020) is used to store and access video data collected from the video input devices (1010). Video data can be stored in the same form as it is supplied from the video input devices (1010), or it can be converted into alternate forms for processing or to improve storage efficiency. In some exemplary embodiments video data is stored in a plurality of forms for diverse purposes.

In exemplary embodiments that support use of non-video data, non-video data can be stored in the form it is supplied in, or converted to other forms for storage, for processing, or for other purposes. Non-video data can be stored in the video storage component (1020), or in one or more other locations (not shown) as determined to be appropriate by those with skill in the art.

The video metadata storage component (1040) is used to store metadata that accompanied, was extracted from and/or was derived from video input data. This comprises, for example, information about video format, collection time, length of video clip, collection location, object metadata, video input device information, video data storage location, security classification data, etc.

The world data storage component (1050) is used to store data that is not directly related to specific video data, but which is useful to the system. For example, video and non-video input device locations, types, capabilities, and control protocol information, definitions for system-defined terms, such as “fast”, “slow”, “big”, “small”, etc. used in filter expressions or for other purposes, object relationship data (e.g., dogs are animals, humans are animals, man and woman are humans, etc.) useful for defining groups of objects, ontology information (e.g., dogs are closely associated with humans, humans are closely associated with cars, trucks, and busses, humans are distantly associated with pigeons, etc.), rules for object interactions, behaviors, and events (e.g., cars can carry people, people can not carry cars, trees do not change location, if a non-mobile object joins with a mobile object and changes location it has been “picked up”, etc.)

The processor arrangement or component (1030) can comprise both parallel processing and distributed processing, using a single device or a plurality of devices. Processing devices can be co-located or in diverse locations. Processing devices can be dedicated to processing video, or have additional uses (e.g., cameras can perform some or all processing of the video they capture). Processing of a given video input stream can be done in a single processing element, or be distributed across a plurality of elements, such as a plurality of general purpose computers, each handling a portion of the processing tasks, by special purpose devices such as FPGAs (Field Programmable Gate Arrays) or ASICs (Application-Specific Integrated Circuits), neural networks, one or a number of processors such as single or multi-core microprocessors, digital signal processors, gate arrays, or other example implementations, or by combinations of these or other processing means known to those with skill in the art.

The user interface (1060) typically comprises some means for displaying video data and informational displays for user interaction, and some means for accepting user control inputs. Display capabilities can be provided by standard monitors, laptops, tablets, smart phones, heads up displays (HUDs), projection systems, or any other available method or device suitable for the purpose as determined by those with skill in the art. User control input can be accomplished using known devices and methods, such as keyboards; touch screens; video motion capture systems; mouse, trackball, trackpad, or light pen pointing devices; data gloves; speech input systems; graphical user interfaces (GUI); command line input methods; or any combination of these or other methods determined to be proper by those with skill in the art.

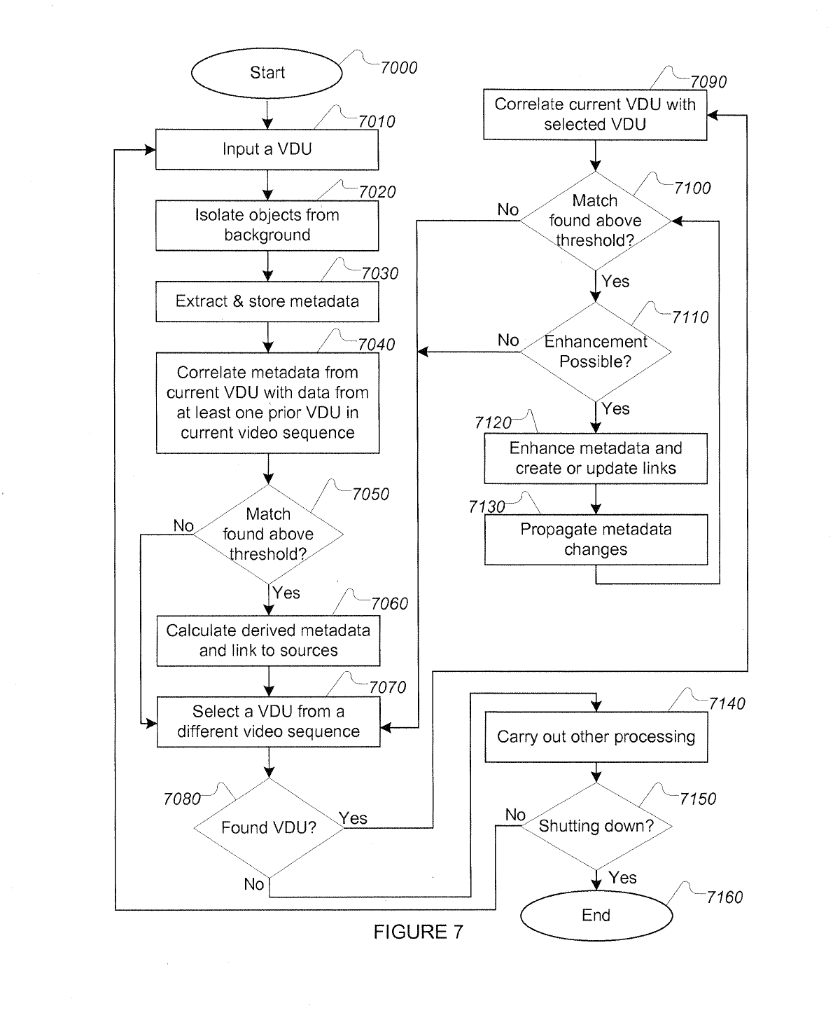

An exemplary process flow is shown in FIG. 7. The process starts (7000) with the input of a VDU to be processed (7010). Input can originate with video data from any acceptable source, in any acceptable format, and can in some exemplary embodiments involve conversion of the data from the original format to a format useful for processing. In other exemplary embodiments such conversion is not carried out and data is processed in the original format.

Once input, the VDU is processed to isolate objects from background (7020). Object isolation can be carried out using any known methods, such as edge detection, movement detection by comparison of the current VDU with temporally adjacent or close VDUs from the same video feed or segment, face detection, optical character recognition (OCR), pattern matching, or other methods. Portions of the VDU not isolated as objects are considered to be background.

The next step is to extract and store metadata (7030). Extracted object metadata comprises information about objects visible in the VDU that can be determined based on the content of the VDU, metadata about the video feed or segment, such as the video capture location, direction of input device view, lens metadata such as aperture or focal length, and non-video data, such as the time of capture of the video, weather conditions at the time of capture, radar data showing object speed or geo-location, audio data, or other non-video data. Extracted object metadata comprises information such as object apparent color, object type, individual object identification, object spatial relationship with other objects or background, geographic coordinates of the object, the object's location in the view, the image data for the object, etc. Extracted metadata is stored for use, and directly or indirectly associated with the VDU, the video feed or segment, and the metadata of these.

Once the object metadata has been extracted from the current VDU and stored, the next step is to correlate metadata from the current VDU with metadata from at least one prior VDU in the same video feed or segment (7040). Correlation involves identification of objects in the two or more VDUs as being the same objects. In some exemplary embodiments, correlation involves identification of objects from the two or more VDUs as being the same objects with a confidence above a specified threshold (7050). In at least some of these exemplary embodiments, a value reflecting the level of confidence with which the objects are identified as being the same object in the diverse VDUs is recorded as metadata.

If an object in the current VDU was not found in a prior VDU, the object has either entered into the view of the video capture device at the time of capture of the current VDU, or it left occultation by other objects or background at the time of capture of the current VDU. In some exemplary embodiments this event is recorded as metadata. The metadata can comprise the VDU that the object first appeared in, the time (e.g., determined from VDU or video feed or segment metadata). If an object in an immediately prior VDU is not found in the current VDU, the object has either left the view of the video capture device prior to the time of capture of the current VDU, or it has become occulted by another object or background prior to the time of capture of the current VDU. In some exemplary embodiments this event is recorded as metadata.

Derived metadata is then calculated (7060) for objects in the current VDU that are matched with a confidence level above a threshold (7050) to at least one object in one or more prior VDUs. Derived metadata is metadata that can be determined based on metadata for the same object, or an object considered to be the same object with a confidence level above a threshold, from diverse VDUs. For example, if the geographic position of an object is different between a first VDU and a second VDU that was captured subsequent to the first VDU, the velocity of the object can be computed based on the distance between the two geographic positions and the difference between the first and second VDU capture times. Derived metadata can comprise information such as speed and direction of travel, path taken, rotation or turn rate, expected time of departure from the scene or next occultation, interactions between objects, object behaviors, predictions of object behavior, etc.

When derived metadata has been calculated (7060) for objects in the current VDU that matched with a confidence above a threshold (7050) to objects in at least one prior VDU, or if there were no such matches (7050), the next step is to use VDUs from other video data to attempt to enhance the metadata of the current VDU and/or the VDUs of the other video data. This process starts by selecting a VDU from a different video sequence (7070). Any video sequence with available metadata is potentially usable for this purpose, however in typical cases only a subset of video sequences with available metadata are likely to be useful for this purpose (e.g., to have at least one object in common). Selection of VDUs and/or the video sequences that contain them can be done by various methods, such as selection of video sequences with overlapping scene coverage; video sequences that were captured in an area near the current VDU's capture location (where “near” can be defined by a configuration setting, an operator input, prior history of success of failure in locating useful video sequences, or by other methods that will be apparent to one skilled in the art); at a time close to the time of the current VDU's capture (where “time close to” is defined by configuration setting, an operator input, prior history of success of failure in locating useful video sequences, sequences with metadata matches above a threshold (e.g., contain enough matching objects), or by other methods that will be apparent to one skilled in the art); that have scene coverage of an area that objects from the current VDU appear to be moving away from; or by combinations of these or other methods. If no VDUs meeting the selection criteria are found that have not already been processed (7080), the process moves on to other types of processing, described below (7140). If at least one VDU meeting the selection criteria is found that has not already been correlated with the current VDU (7080), the selected VDU is correlated with the current VDU (7090) to identify objects as being present in both VDUs with a confidence level above a threshold. If no objects are found present in both VDUs with a confidence level above a threshold (7100), another VDU is selected (7070), if there is one (7080), and correlated (7090). In some exemplary embodiments, a plurality of VDUs can be selected and correlated in parallel.

For objects that are correlated with a confidence above a threshold between the current VDU and a second VDU (7100), a check is made to determine whether enhancement of either VDU's metadata is possible based on the metadata of the other VDU (7110). For example, the current VDU may have identified an object as being of type “person”, but did not contain sufficient data to determine the identify of the person, while a second VDU with an object of type “person” did have sufficient data to determine the identity of the person, such as through facial recognition processing. If the two person objects are determined to be the same person, with a confidence above a threshold, the metadata with the identity of the person from the second VDU can be applied as metadata for the current VDU, thus enhancing the current VDU's metadata usefulness. Where enhancement of a first VDU's metadata is found to be possible based on a second VDU's metadata (7110), the first VDU's metadata is enhanced and additional metadata comprising a linkage between the first VDU's metadata and the second VDU's metadata is created to record the dependency of the first VDU's metadata on the metadata of the second VDU's metadata (7120). The linkage in some exemplary embodiments is from the second VDU to the first VDU. In some other exemplary embodiments, the linkage is bi-directional or from the first VDU to the second VDU. Such linkage enables adjustment of the first VDU metadata in the event that the second VDU's metadata is changed in a way that affects the enhancement of the first VDU's metadata. For example, if an updated facial recognition processing system determines that the previous identification of the person was in error.

In some cases where a first VDU's metadata is altered based on a second VDU's metadata, whether for enhancement or as a result of a change in the second VDU's metadata, the first VDU's metadata will have been used to enhance a third VDU's metadata. When the first VDU's metadata is changed based on the second VDU's metadata, the change can result in a need to alter the third VDU's metadata. Such dependency chains can involve a plurality of VDUs, and a change to a first VDU's metadata can result in changes to all VDU's that directly or indirectly depend on the first VDU's metadata. Therefore, once enhancement of a VDU has been carried out, and the linkage between its metadata and the metadata of at least one other VDU has been established (7120), the next step is to propagate metadata changes to any other linked VDUs (7130).

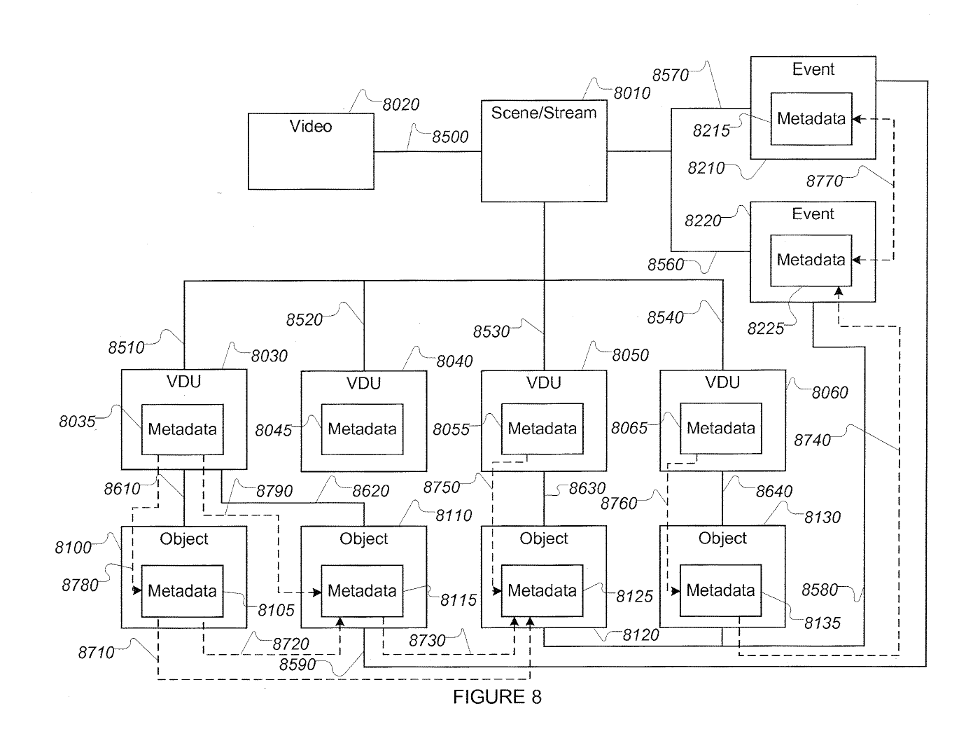

FIG. 8 shows an exemplary data schema for the data collected or derived during processing for a scene or portion of a video stream. The data schema shown in FIG. 8 is a logical representation, and in an embodiment the records depicted can be implemented as single data records, a plurality of separate data records that together comprise the required data, can be stored in a single location or distributed across a plurality of storage locations, can be stored in a sequential file, indexed file, database management system, or any other storage arrangement deemed appropriate by those with skill in the art. Where linkage between records is shown (8500, 8570, 8560, 8510, 8520, 8530, 8540, 8610, 8620, 8630, 8640, 8580, or 8590), an embodiment can implement such linkages using pointers, hashes, named storage locations, address references, or any other method for relating one datum to another as will be well understood by those with skill in the art.

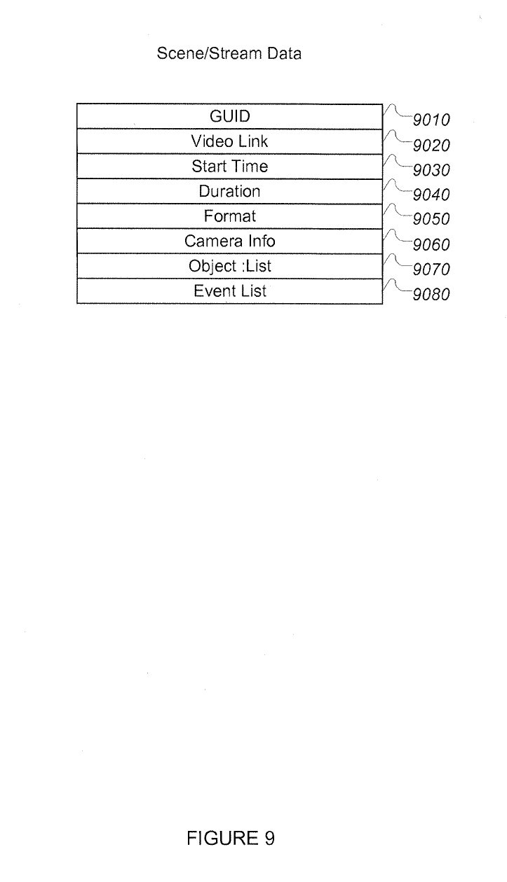

The video data (8020) input is stored and a scene/stream data record (8010) is created with reference to it and description of it. An exemplary scene/stream data record (8010) is shown in FIG. 9.

The scene/stream data record in an exemplary embodiment comprises a globally unique identifier (GUID) data item (9010) useful to refer to a specific scene/stream data record. The scene/stream data record in an exemplary embodiment comprises a Video Link data item (9020) useful for referring to or locating the stored video data of a scene or stream. The scene/stream data record in an exemplary embodiment also comprises a Start Time data item (9030) specifying the time at which capture of the video data was begun. The scene/stream data record in an exemplary embodiment also comprises a Duration data item (9040) specifying the length of the scene. In at least some embodiments, a specified Duration data item (9040) value indicates that the video data is a stream with no fixed length, rather than a fixed duration scene. For example, a Duration value (9040) of minus one, null, or zero can be used to indicate that the scene/stream data record (8010) contains stream data. In some exemplary embodiments, a negative Duration value (9040) can be used to indicate the length of the data collected from a video stream to date. The scene/stream data record in an exemplary embodiment also comprises a Format data item (9050) useful for specifying the format of the video data input (e.g., MPEG-4, MPEG-2, H.264, etc.), or other information about the video data, such as pixels per frame, bit rate, color depth, etc. The scene/stream data record in an exemplary embodiment also comprises a Camera Info data item (9060) useful for storing information about the video input device used to capture or supply the video data. Camera data can consist of such things as camera make and model, camera location at the time of video capture, camera settings at the time of video capture, camera capabilities (e.g., remote pan/tilt/zoom capability, maximum aperture, focal length, etc.), or other camera-related data. The scene/stream data record in an exemplary embodiment also comprises an Object List data item (9070). An Object List data item (9070) is a set of references to Object data records that each describe an object identified in one or more VDUs of the scene or stream. In some exemplary embodiments objects must be identified with a confidence value exceeding a threshold, in a number of VDUs exceeding a threshold, or meet other requirements before they are included in the Object List data item (9070) of a scene/stream data record. The scene/stream data record in an exemplary embodiment also comprises an Event List data item (9080). An Event List data item (9080) is a set of references to Event data records that each describe an event identified in one or more VDUs of the scene or stream. In some exemplary embodiments events must be identified with a confidence value exceeding a threshold, extend over a number of VDUs exceeding a threshold, be one of a set of specified event types, or meet other requirements before they are included in the Event List data item (9080) of a scene/stream data record.

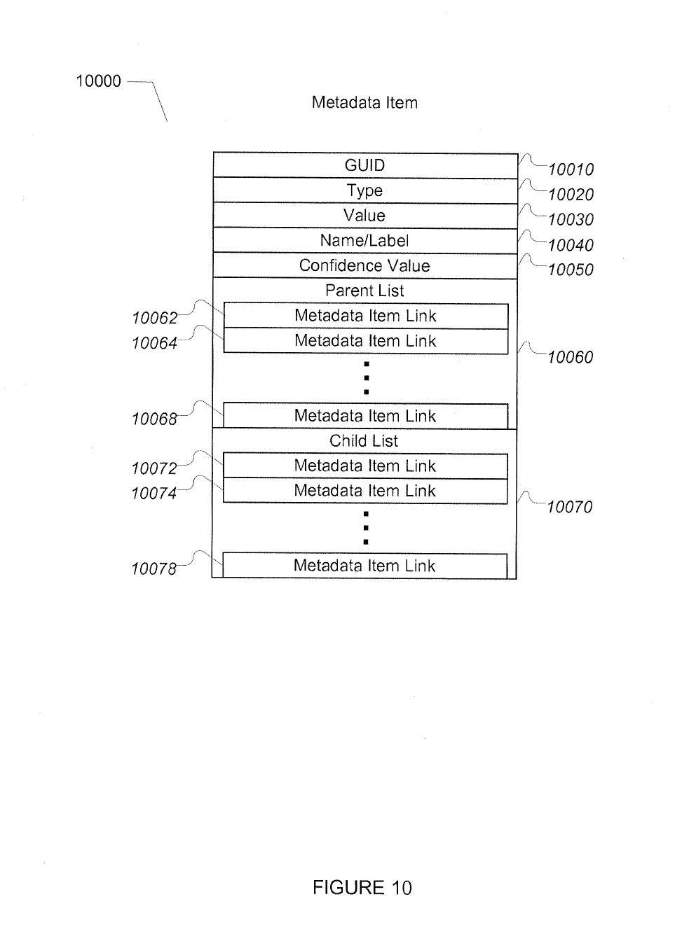

Some of the data record types depicted in FIG. 8 comprise one or more Metadata Items (8035, 8045, 8055, 8065, 8105, 8115, 8125, 8135, 8215, & 8225). An exemplary Metadata Item data record (10000) is shown in FIG. 10. A Metadata Item data record in an exemplary embodiment comprises a globally unique identifier (GUID) data item (10010) useful to refer to a specific Metadata Item data record (10000). The Metadata Item data record in an exemplary embodiment also comprises a Type data item (10020) useful for specifying the type of metadata contained in the Metadata Item data record (10000). In some exemplary embodiments the Type data item (10020) is limited to a value indicating that the metadata was collected or a value indicating that the metadata was derived using other data and/or metadata. In other exemplary embodiments, the Type data item (10020) can contain other values indicating other or additional information about the type of the Metadata Item, such as the kind of value stored in the Value data item (10030). The Metadata Item data record in an exemplary embodiment also comprises a Value data item (10030), useful for storing the value of the metadata item (e.g., an object link, an event link, a color, a speed, a location, an object identifier, a trajectory, etc). The Metadata Item data record in an exemplary embodiment also comprises a Name/Label data item (10040) useful for storing a name or label associated with the Metadata Item. The Metadata Item data record in an exemplary embodiment also comprises a Parent List data item (10050). The Parent List data item (10050) comprises a set of Metadata Items or a set of references to Metadata Items (10062, 10064, & 10068)), that were used to derive one or more data items of the Metadata Item (10000), such as the Value (10030). Should any of the Metadata Items contained in or referenced by the Parent List be changed, it is possible that the derived data items of the Metadata Item (10000) must be re-derived, and the Parent List is useful for maintaining linkage between derived data and the data used in its derivation. The Metadata Item data record in an exemplary embodiment also comprises a Child List data item (10070). The Child List data item (10070) comprises a set of Metadata Items or a set of references to Metadata Items (10062, 10064, & 10068)), that have data derived from one or more data items of the Metadata Item (10000), such as the Value (10030). Should any of the Metadata Item data items be changed, it is possible that the derived data items of the Child List Metadata Items (10072, 10074, & 10078)) must be re-derived, and the Child List is useful for maintaining linkage between derived data and the data used in its derivation.

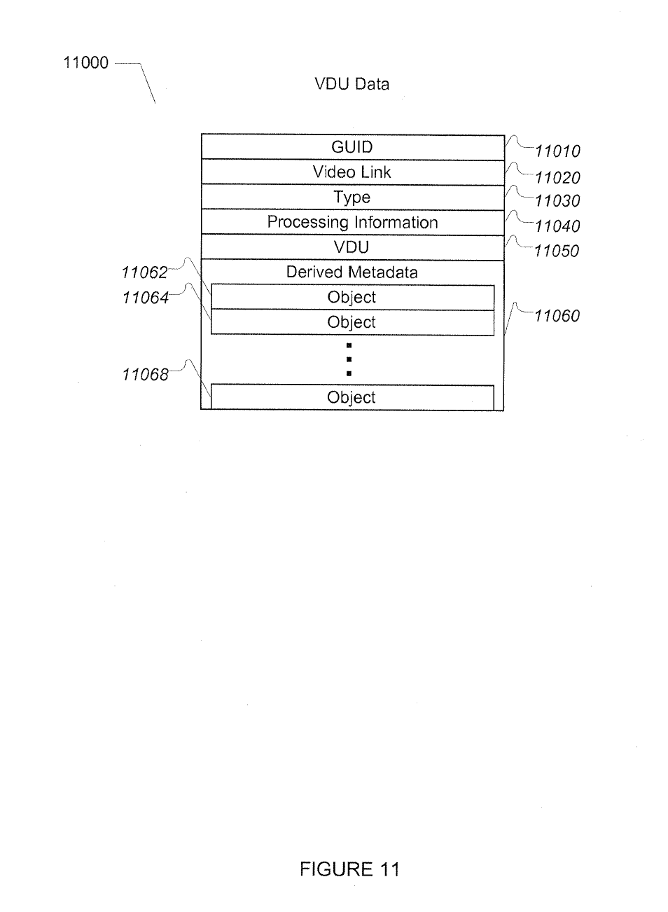

The video data (8020) input is processed as a sequence of VDUs. Each VDU is stored as a VDU Data record (8030, 8040, 8050, & 8060). An exemplary VDU Data record is shown in FIG. 11 (11000). The VDU Data record (11000) in an exemplary embodiment comprises a globally unique identifier (GUID) data item (11010) useful to refer to a specific VDU Data record (e.g., 8030, 8040, 8050, or 8060). The VDU Data record in an exemplary embodiment also comprises a Video Link data item (11020) useful for specifying the location in the video input data (8020) where the VDU Data record data (11000) originated. The Video Link data item (11020) can comprise a frame number, time code, and/or other data useful for the purpose. The VDU Data record in an exemplary embodiment also comprises a Type data item (11030) useful for specifying information about the type of the VDU data, such as an indication of the format of the VDU data where this is different from the input video data (8020). The VDU Data record in an exemplary embodiment also comprises a Processing Information data item (11040) useful for specifying whether processing of the VDU is complete, the method and/or software used for processing the VDU, the resources used in processing the VDU, or other data related to the processing of the VDU initially or over time. The VDU Data record (11000) in an exemplary embodiment also comprises a VDU data item, useful for containing a VDU or referencing a storage location for a VDU. The VDU Data record (11000) in an exemplary embodiment also comprises a Derived Metadata data item (11060) containing a set of Metadata Items, a set of references to Metadata Items, or a reference to a set of Metadata Items or a set of Metadata Item references. The Metadata Items contained in or referenced by the Derived Metadata data item (11062, 11064, & 11068)) specify Object Data records (8100, 8110, 8120, & 8130) for objects identified in the VDU (11050) by the processing of the VDU (11050).

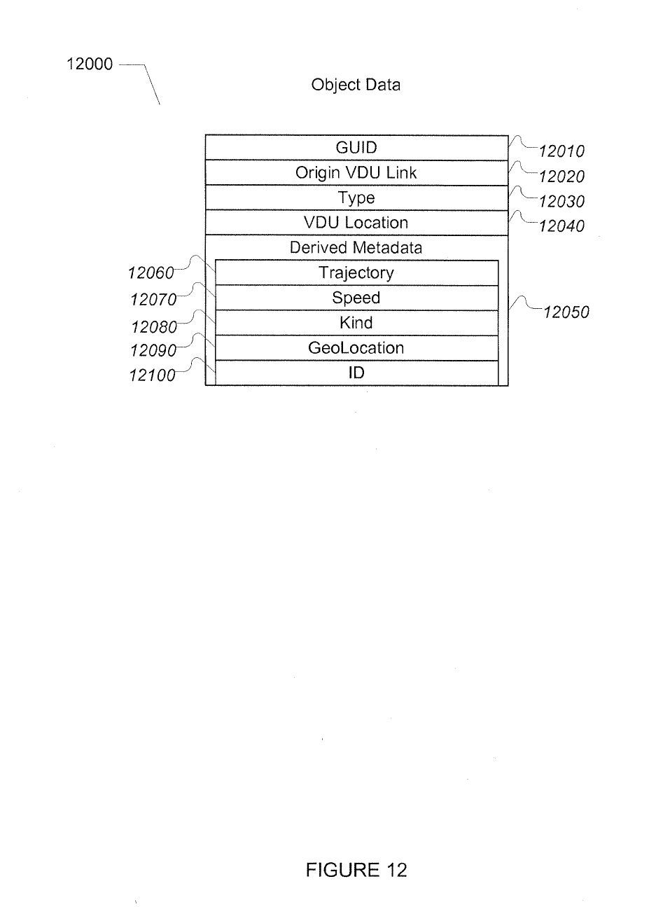

Data about objects identified in VDUs taken from the video input (8020) are stored in Object Data records (8100, 8110, 8120, & 8130). An exemplary Object Data record is shown in FIG. 12 (12000). The Object Data record (12000) in an exemplary embodiment comprises a globally unique identifier (GUID) data item (12010) useful to refer to a specific Object Data record (8100, 8110, 8120, or 8130). The Object Data record in an exemplary embodiment also comprises an Origin VDU Link data item (12020) useful for determining the VDU (8030, 8040, 8050, or 8060) that the object was found in. The Object Data record in an exemplary embodiment also comprises a Type data item (12030) that stores the identified object's type (e.g., stationary/moving, pixel blob, etc.). The Object Data record (12000) in an exemplary embodiment also comprises a VDU Location data item (12040) that stores information about where in the VDU the object was located, such as pixel coordinates within a frame, or a byte offset within the VDU data. The Object Data record (12000) in an exemplary embodiment also comprises a set of derived metadata items (12050), such as the Trajectory (12060) of the object within in the scene; the Speed (12070) of the object within the scene; the Kind (12080) of object the object has been identified as being (e.g., vehicle, animal, human, building, sign, cloud, etc.); the GeoLocation (12090) of the object; or an ID (12100) for the object. The ID (12100) of the object can be a facial recognition result, a license plate OCR result, a result of correlation between two or more VDUs from one or more scenes and/or streams that matched objects in the two or more VDUs as being the same object, optionally with a confidence value above a threshold, and as such can be useful to identify an object as being the same object as an object identified from other VDUs. Such cross-VDU object matching can enable derivation of metadata, such as speed, trajectory, object kind, potential future locations, etc. The set of derived metadata items (12050) can comprise other kinds of metadata, or be empty, for a given Object Data record (12000).

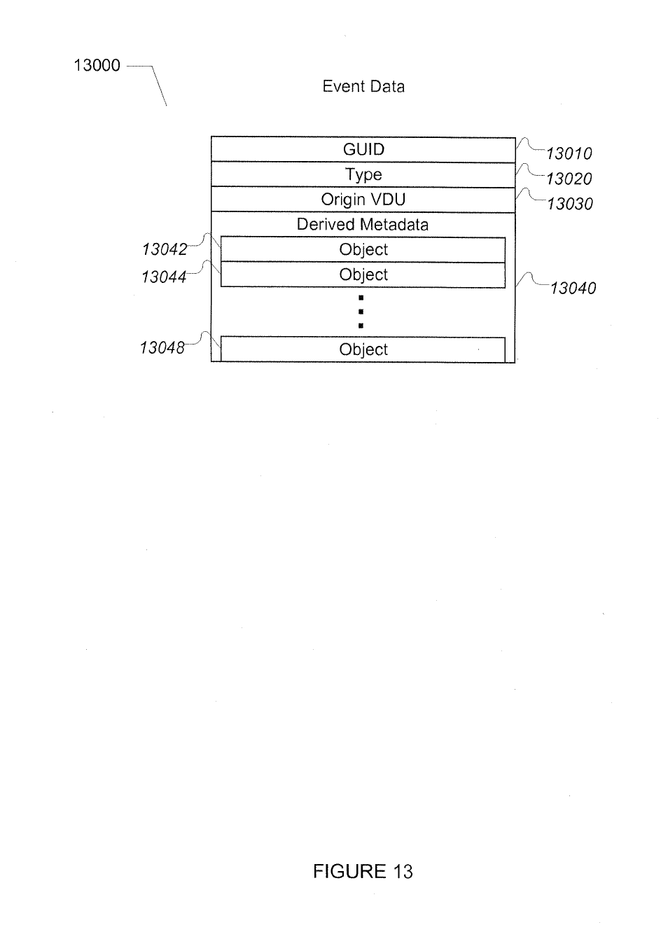

Data about events identified in VDUs taken from the video input (8020) are stored in Event Data records (8210 & 8220). An exemplary Event Data record is shown in FIG. 13 (13000). The Event Data record (13000) in an exemplary embodiment comprises a globally unique identifier (GUID) data item (13010) useful to refer to a specific Event Data record (8210 or 8220). The Event Data record (13000) in an exemplary embodiment also comprises a Type data item (13020) useful for storing the type of event represented by the Event Data record (e.g., object interaction, audio alarm, object separating from another object, object joining with another object, object occlusion, object of interest recognized, etc). The Event Data record in an exemplary embodiment also comprises an Origin VDU data item (13030) useful for recording the GUID of, or other reference to, the earliest VDU that contains data relevant to the event represented by the Event Data record (13000). The Event Data record (13000) in an exemplary embodiment also comprises a set of zero or more Derived Metadata data items (13040), such as references to Object Data records (13042, 13044, & 13048) for the objects involved in the event represented by the Event Data record (13000). Derived Metadata data items (13040) are not limited to references to Object Data records (12000), and can contain any Metadata Item data records (10000) deemed useful or appropriate by those with skill in the art.

As shown by the dashed lines in FIGS. 8 (8750, 8760, 8710, 8720, 8730, 8740, 8770, 8780, & 8790), and the description of the Parent List (10060) and Child List (10070) Metadata Item (10000) record description herein, there can be linkages between Metadata Item records of various data records (e.g., VDU Data (11000), Object Data (12000) or Event Data (13000)). These linkages are useful for updating derived metadata when the data the metadata was derived from is changed. For example, if the processing methods for extracting speed data for objects from VDUs are changed to correct errors in the prior methods that led to incorrect speed results, the objects can have their speed metadata re-calculated to correct the errors, but if the incorrect speed results were used to help determine object kind (e.g., the object being a dog was ruled out because the speed was calculated as 50 mph), the object kind also needs to be re-evaluated. The linkages between Metadata Items (e.g., 8720 or 8730) are useful for determining which metadata must be re-evaluated, without the inefficiency of having to re-evaluate all objects. In some cases the re-evaluation of metadata for a first object can result in a need to re-evaluate the metadata for a second object. For example, in FIG. 8, at least some of the metadata of object 8100 (8105) is parent metadata for at least some of the metadata of objects 8110 (8115) and 8120 (8125). If the metadata of object 8100 (8105) changes, the metadata of the other two objects may have to be changed as well. If such changing of metadata results in changes to the metadata of object 8110 (8115), which is a parent of at least some of the metadata of object 8120 (8125), then object 8120's metadata (8125) may require re-evaluation again. As shown in FIG. 8, it is possible for a data record's metadata to be a parent to a plurality of other data records (8105), be a child of a plurality of other data records (8125), be both a parent and a child to other data records (8115), and for data records to be parent and child of each other (8770).

Continuing with FIG. 7, when all correlated objects have been processed (7100), the next selected VDU is processed for correlations (7070). When all have been processed (7080), other processing is performed (7140). Other processing can comprise user interaction for selective viewing of video data, tracking of objects within or between scenes, determination of object interactions that meet specified criteria, detection of events, prediction of events, detection of the failure of predicted events to occur, and detection of inferred events. Inferred events are events that are not captured in any VDU, but which can be inferred from metadata associated with VDUs. For example, one or more VDUs may show a lack of southbound traffic on a road that is normally very busy, indicating that there may be a blockage to the north of the scene showing the lack of traffic. Inferred events can be defined by rules, or other well understood methods common in artificial intelligence (AI) work, and can trigger actions and metadata adjustments similarly to the way events that occur in a scene can.

Once other processing resulting from processing the current VDU is complete, a check is made to see if the system is shutting down (7150). If it is, the process is complete (7160). If the system is not shutting down (7150), the next VDU is input (7010) and the process repeats.

### Selective Video Data Display

In many cases, there will be a single video input device covering a particular scene. As used herein, the term “scene” refers to the portion of the real world viewable by a video input device, such as a camera. The video input device may or may not view the entire scene at all times. For example, at a given time a camera may be zoomed to view only a portion of a scene.

When video that is of interest has been recorded by a single camera viewing a scene, as might be the case for a security camera, process monitoring camera, traffic camera, or the like, the following method for interaction with a user of an exemplary embodiment can be useful for improving the ease and speed of analysis, and for discovering aspects of the video not readily apparent by simply watching the recorded video. The method has five steps:
1. Access at least one video clip of the scene and identify objects in the clip or clips.
2. Construct an image or video clip of the scene that does not contain any of the identified objects (a “cleared background”).
3. Provide a list of the identified objects to a user, where the list is filtered according to a specification provided by the user.
4. Allow the user to select one or more of the identified objects from the list of step 3.
5. Display the objects selected in step 4, overlaid on the cleared background of step 2,

Separation of identified objects from the scene background can be done using known methods for separating objects from background in video. Once identified as individual objects, metadata is extracted and/or derived for them. Metadata can be useful to aid in identification of additional metadata for objects in exemplary embodiments, or for increasing confidence scores. For example, where movement characteristics (e.g., speed, direction, position within frame, etc.) are included in metadata, those objects with movement beyond a threshold value can be considered to be moving objects in at least some exemplary embodiments. The use of a threshold value is useful to avoid considering pixilation variations in cameras, wind movement in leaves, or other such factors, as object movement. Objects identified as being of particular types can inherit metadata associated with the type, such as size ranges, speed capabilities, etc.

Construction of a cleared background image or video clip can be done using known methods such as tiling background samples taken from one or more VDUs, where each tile is a sub-set of a VDU image and the tile contains identified object imagery. In cases where there is no video frame available from which a tile can be taken for a portion of a cleared background, default imagery can be used in place of such tiles. Default imagery can be a color and/or pattern that indicates a default imagery tile, a tile taken from a similar scene, such as from video taken by another camera with a view of the same or similar location, etc.

In some exemplary embodiments, filtering of the list of identified objects can be done using any metadata characteristic, or combination of characteristics. Specification of the metadata characteristics and their relationships can be carried out using any known method or combination of methods, such as database query language specification (e.g., SQL), XML documents describing objects for inclusion or exclusion, checkbox lists of objects to include or exclude, threshold values required for inclusion or exclusion, minimum confidence values required, etc. In some other exemplary embodiments representations of each identified object (e.g., an icon, an image taken from one or more VDUs, or a processed image taken from one or more VDUs) are displayed in a manner indicating one or more metadata characteristics of the object. For example, larger objects can be shown larger than smaller objects, objects can be arranged with faster objects to the right and slower objects to the left, objects can be sorted and grouped by color, location in the frame, or direction of travel, etc.

Filter requirements, such as color, speed, direction, etc. can be specified in terms of the data and data types used for the metadata in some exemplary embodiments. For example speed can be specified in units such as miles per hour (mph), meters per second (mps), or kilometers per hour (kph). In some exemplary embodiments values can be specified using terms defined by the configuration of the system or by operators of the system. For example, the term “fast” can be defined as a speed greater than 40 mph, and “slow” as a speed less than 10 mph. This enables filtering of only fast or slow objects be included in the list of non-background objects. Use of such terms can simplify filter specification entry for operators, and lead to standardization and ease of redefinition within an organization.

Selection of objects can be done by having a user enter one or more associated object IDs, by using a pointing device to indicate one or more objects to select, by voice input of object IDs or other indication of one or more objects, or by other means as will be well understood by those with skill in the art.

In some exemplary embodiments, display of selected objects can be done separately or simultaneously as specified by a user. Display is done against the cleared background, making it easy to see and follow each selected object as the video is played back, and to determine the relationships and interactions between them, without distraction by other objects that are not of interest and that are therefore not selected and not displayed. Objects can be displayed as icons representing the position in the frame of the object in the original video clip, or the image of the object from the video clip can be used, clipped to just show the portions of the video frame occupied by the object. In such exemplary embodiments, clipping can follow the outline of the object frame by frame, or clipping can be approximate, such as a circle, oval, or polygonal shape. In some exemplary embodiments, objects can be displayed as both images from the video clip and as icons or other graphics at the same time. Icons and graphics can be used to represent metadata about the object, such as its ID, speed, type, direction of travel, the length of time it is visible or will remain visible, etc.

Display of a plurality of objects can be done in a relative real-time mode in some embodiments when requested. That is, if a first object appeared in the scene at 1:00 pm and left the scene at 1:10 pm, and a second object appeared in the scene at 4:00 pm, and left the scene at 4:20 pm, display at relative real-times would not show them at the same time . . . the first object would leave the cleared background prior to the second object appearing, as actually happened when the video was recorded. Playback of the video for the time between the first object leaving and the second object appearing can optionally be suppressed.

Display of objects can be done in an overlapped time mode in some embodiments when requested. That is, if a first object appeared in the scene at 1:00 pm and left the scene at 1:10 pm, and a second object appeared in the scene at 4:00 pm, and left the scene at 4:20 pm, display in overlapped time mode would show both objects simultaneously. Such a mode is useful for determining whether the displayed objects followed the same path, what the relative speed of movement was, how their interaction with other objects varied or was similar, etc. For example, did two people stop and smell the same flower? Did a car slow in front of the same jewelry store each time it drove by? When there are many objects over time, overlapped time display can make patterns of activity more obvious than if the objects are shown separately at relative real-times.

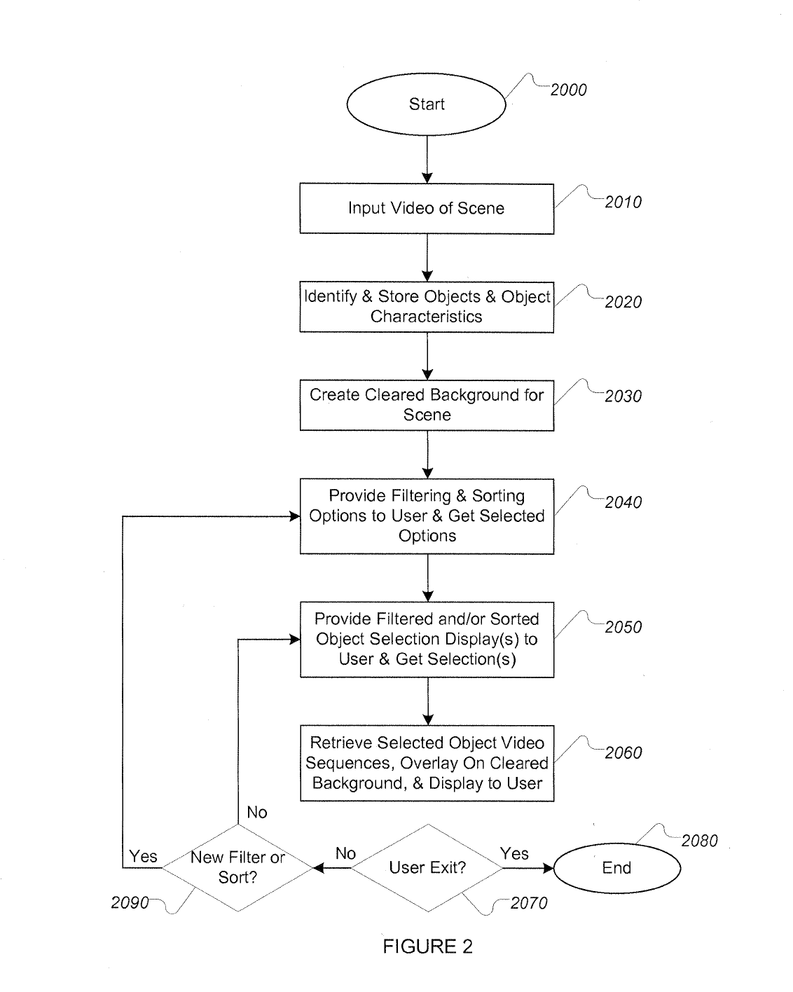

FIG. 2 shows a flowchart of an exemplary embodiment processing method for viewing video in a single video input, single scene scenario. The process (2000) starts with input of at least one video sequence of a scene (2010). The next step is to identify all objects in the video sequence as independent objects and extract or derive metadata for them (2020). This can be done using the VDU processing methods described herein. Object identification and characteristic metadata is stored in the video metadata storage (1040).

The next step is to create a cleared background of the scene (2030). This is a view of the scene with the identified objects removed. It can be a video sequence or a still image, depending on implementation or configuration of the exemplary embodiment of system. Removal of identified objects can be accomplished using known methods, such as “stitching” together sub-parts of the scene that occur between identified objects from a plurality of VDUs until the entire scene has been constructed minus the identified objects. In some cases, where some portions of the scene are never clearly visible due to obscuration by identified objects, assumptions may be necessary to fill in the missing portions. For example, it might be assumed that adjacent areas that were visible in one or more frames merge smoothly into each other, so interpolation can be used to fill in the missing areas. Alternatively, real-world knowledge can be used to aid in filling gaps. For example, if a sidewalk exists in the scene, and a segment of it is obscured, real world knowledge might indicate that the obscured portion is linearly connected to the visible portions, permitting a copy of a visible portion to the obscured portion. When no more preferable method exists to resolve an obscuration problem, the gap area can be filled with a pattern indicating this.

The next step is to provide the user with filtering and/or sorting options useful for selecting objects for inclusion in the scene and determination of the user's desired selection mode (2040). The options can include object identifications (types, assigned object IDs), required characteristics, ontological or other groupings, sort order specifications (ascending/descending, alphabetical, by size, by speed, etc). Options can be shown as lists, in a GUI (e.g., radio buttons, check boxes, drop down lists, tabbed windows, etc.), input as commands, or in any other known manner. Options are related to metadata associated with one or more video sequences.

The next step is to display the identified objects according to the selected filter and/or sort option selected and enable the user to select one or more objects to include overlaid in a display of the cleared background of the scene (2050). Objects can be listed by ID, shown as icons, shown as stills from the video sequence, shown as video sequences of the specific object, described by characteristic or range of characteristic (e.g., a set of speed ranges, with any object having a speed characteristic within a selected range being selected for inclusion), or by other methods that will be apparent to those with skill in the art.

Once the user has selected one or more objects for inclusion (2050), the next step is to retrieve the video of the selected objects from video storage, and or the object's icon from video metadata storage, and overlay them on the cleared background and display the constructed sequence to the user (2060). Sequences for each object can be included in the scene in their original temporal relationships, be compressed in time so that time periods without selected objects are omitted from the overlaid sequence, or be overlaid without regard to the original temporal relationship (i.e., all shown at the same time, even if they didn't happen at the same time). Overlaying without regard to original temporal relationships can be useful to show similarities and differences in, for example, path taken through the scene to identify outliers, determine the most commonly used trajectory, etc.

If the user chooses to exit (2070) the process is complete (2080). If the user chooses not to choose a different filter or sort method (2090), a different set of objects can be selected using the same filter or sort method (2050) and overlaid on the cleared background (2060). If a different filter or sort method is desired (2090) the process returns to the step where this is chosen (2040) and carries on from there as before.

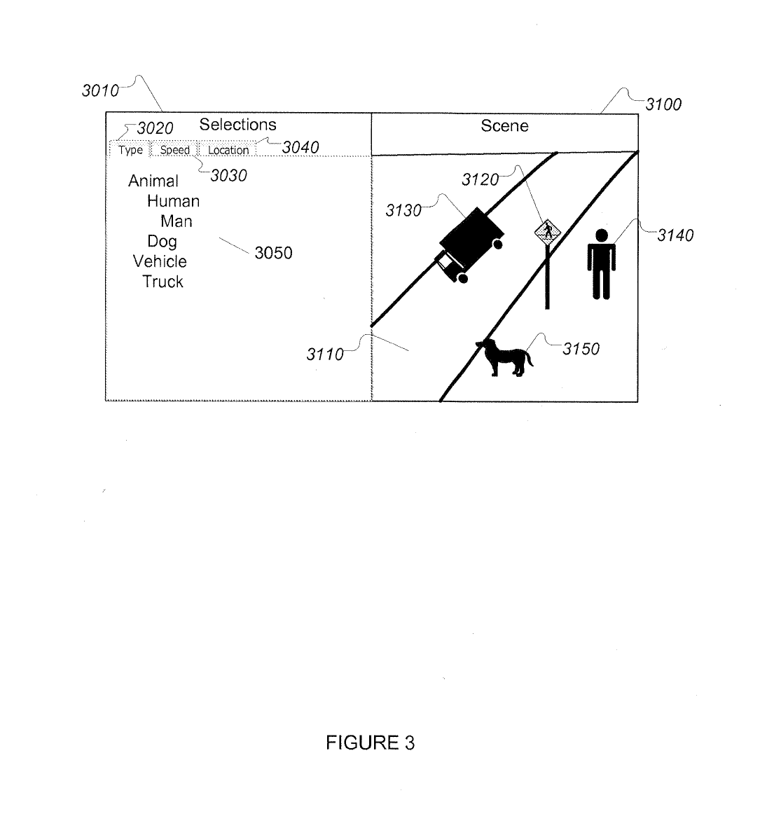

FIG. 3 shows an exemplary user interface that employs a GUI. This comprises a selections window (3010) and a scene display window (3100). The selections window comprises a set of tabbed panes (3020, 3030, & 3040) each for a different filter or sort option and each containing a different mode of displaying available objects (3050). The scene window (3100) comprises a display of a cleared background and several overlaid video sequences. For purposes of this example, the video sequence includes a cleared background comprising a roadway (3110) and a road sign (3120), and three non-background objects: a truck (3130), a human (3140), and a dog (3150).

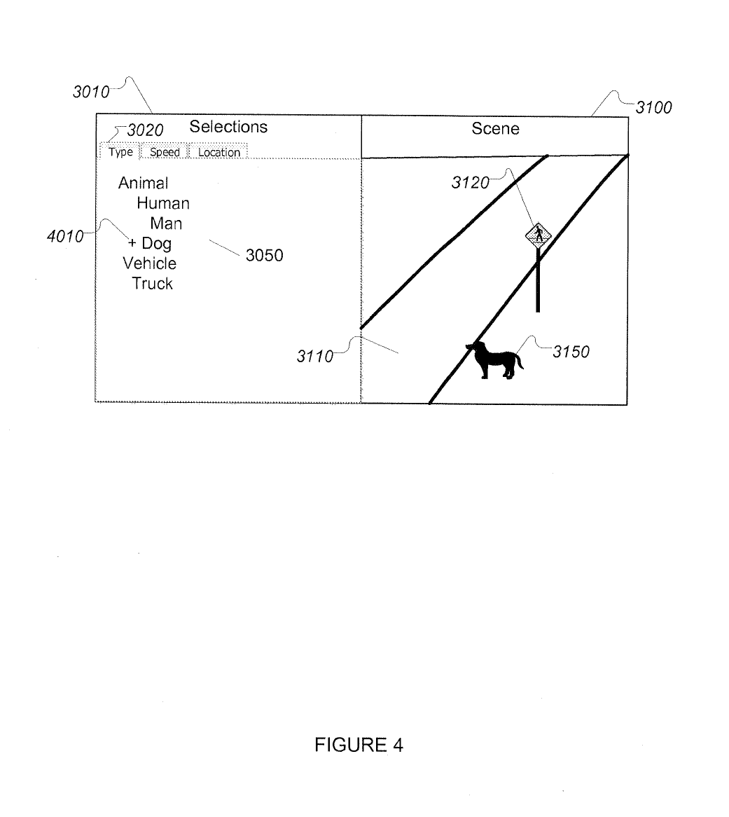

FIG. 4 shows the exemplary user interface of FIG. 3, with the “Type” tab selected (3020) in the selections window (3010). On the Type tab (3020) the “Dog” object type has been selected, as indicated by the “+” icon (4010). This results in the dog object (3150) being overlaid on the cleared background of the scene (3110 & 3120). Other identified object types are not included in the display, as they are not of object type “dog”.

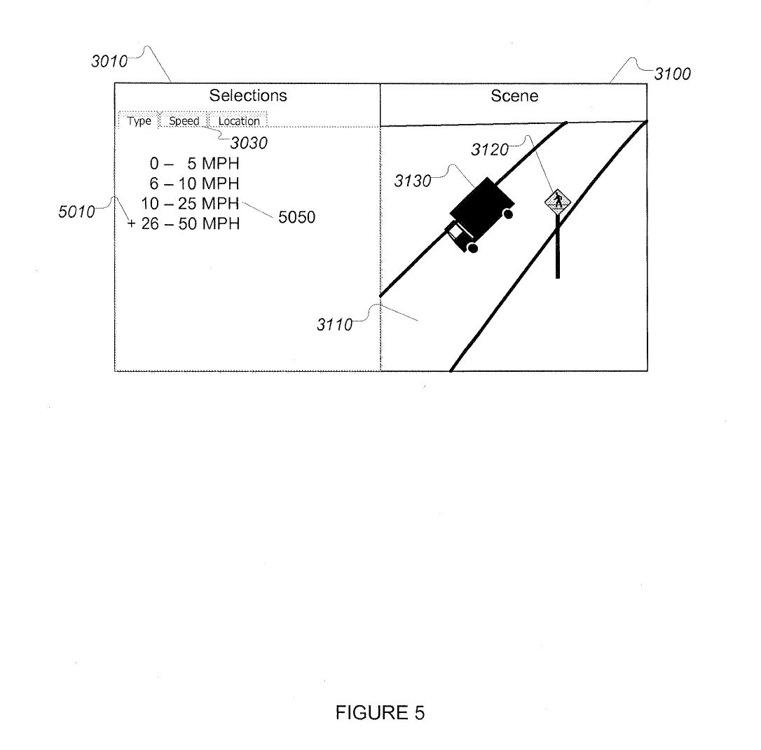

FIG. 5 shows the exemplary user interface of FIG. 3, with the “Speed” tab selected (3030) in the selections window (3010). On the Speed tab (3030) the “26-50 MPH” speed range (5050) has been selected, as indicated by the “+” icon (5010). This results in the truck object (3130) being overlaid on the cleared background of the scene (3110 & 3120), as it is the only object in the scene traveling at that speed. The dog (not shown) and the human (not shown) are not included in the displayed scene as they are either not moving, or are moving slower than 26 MPH.

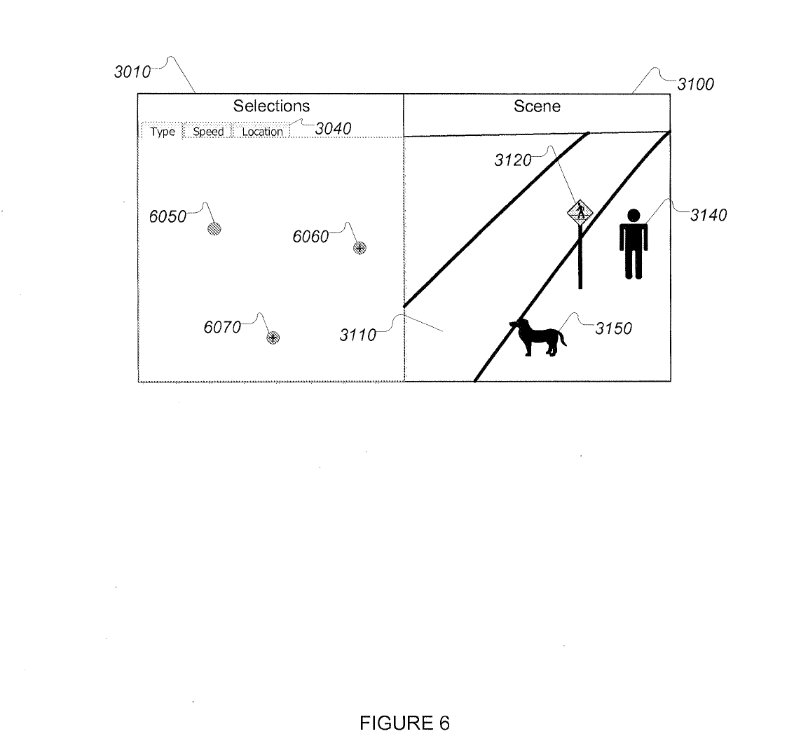

FIG. 6 shows the exemplary user interface of FIG. 3, with the “Location” tab selected (3040) in the selections window (3010). On the Location tab (3040) there are three icons displayed (6050, 6060, & 6070) in locations analogous to the starting locations of the three objects available for inclusion in the scene. Two of the icons have been selected, as indicated by the “+” icons (6060 & 6070) and the corresponding objects have been included in the displayed scene (3140 & 3150). The truck (not shown) was not included since its icon (6050) was not selected. Display of icons for the available objects in their relative positions within the scene permits easy inclusion of objects in a given area. Icons can be selected individually, or “lassoed” using well understood GUI methods. The example shows icons in positions relative to the object positions in the scene, but alternatively real-world position data can be determined for each object using known methods and the icons shown on a map of the scene area.

Single Scene with a Plurality of Viewpoints

In some cases there will be a plurality of video inputs that view a single scene, or portions thereof, from a variety of viewpoints. This can occur, for example, when a plurality of video capture devices are installed with overlapping fields of view, when video capture devices are re-pointed to cover an event from a plurality of viewpoints, or when video data is supplied by bystanders to an event of interest who happened to be recording at the time it occurred (e.g., the 2013 Boston bombing, a witness to an accident with dashboard camera video, or a news crew recording the event for program use).

The quality of the video may vary widely between video input sources. Some of the video input sources may not supply accurate location metadata, camera setting data, or other useful metadata. Due to transmission path differences, or video data being supplied after the fact, video input sources may not be synchronized, and may have different time resolutions where time data is supplied. Correlation between VDUs of diverse video inputs during processing as described elsewhere herein can reduce the effects of such variations in the quality and completeness of video inputs on the quality of the stored metadata. For example, where video quality is low it can be problematic to identify objects. If a difficult to identify object in a first video input can be correlated with a clearer view of the same object from a second video input, the identification from the second video input's metadata can be used for the first video input's metadata identification of the same object, thus enhancing the first video input's metadata completeness. Correlation of a first and second video input can be done using camera location and pointing metadata, capture time data, or other metadata to calculate the scene overlap of the two inputs. Alternatively or additionally, correlation can be done by identifying objects in the first video input as being the same objects as in the second video input. In some cases, such as face recognition or license plate reading, this may be possible to do directly, while in other cases the identification may be probabilistic, such as by determining that each video input is showing the same number of objects, of the same types, moving in similar manners. Confidence values can be associated with metadata to indicate the probability that the correlation was good.

Correlation between video inputs can also be used to enhance video capture device location and pointing metadata. For example, if a first video capture device is in a known location, but a second video capture device recording the same scene is not, the location of the second video capture device can be computed from the apparent locations of the objects in its view combined with information on the actual object locations as determined by the first video capture device's view.

Correlation between video inputs can also be used to enhance time-related metadata. For example, if a first video input device has more accurate or precise time-related metadata than a second video input device, and the two video input devices can be synchronized by correlating object movement timing, the time of occurrence of an event (e.g., a gunshot, a traffic light change, etc.) between the two, the time-related metadata of the second video input device can be enhanced by using the time-related metadata of the first video input device. Enhancement can refer to the second video input device's metadata including time-related metadata at all, or just that the precision or accuracy of such metadata is improved. When metadata from first VDU is used to enhance metadata of a second VDU, a link is created between the metadata that was enhanced and the metadata used to enhance it. Such links can be unidirectional (e.g., from the enhanced metadata to the source metadata used to enhance it), or bi-directional so as to enable determining what metadata a given metadata item has been used to enhance as well as to enable determination of the metadata used to enhance a given metadata item.

In some cases a given object will be occluded by other objects as it moves through a scene as viewed from a first video input location. Metadata about its location, speed, direction, etc. during such periods of occlusion will be based on assumptions, or missing, unless such metadata can be supplied based on other video inputs with viewpoints where the given object is not occluded. Using metadata from such other video inputs can enable accurate metadata for the first video input even during times when objects are occluded. This can enable display of object location, such as by graphical overlay of an icon, outline, or other such method, on a view of the video from the first video input, and enable useful analysis results that would otherwise be unavailable. In real-time video scenarios, where cameras are being re-pointed to track a particular object, metadata from a second video input can enable tracking to continue during periods of object occlusion, possibly preventing loss of video coverage from the first video input when the object emerges from occlusion.

When working with video of a scene from a plurality of video capture devices the creation of a cleared background for use in a user interface as described herein for working with a single video capture device input can be problematic. With a plurality of views, a single cleared background of the sort described above can be inappropriate or confusing, since some of the selected objects' video images might have been recorded from a different location than the cleared background or from each other. To deal with this situation a cleared background can be synthesized using computer graphics methods, and the selected objects located appropriately within it. Use of icons to indicate object locations can be beneficial in such cases. In some exemplary embodiments access to one or more video views and/or metadata of selected objects can be linked to such icons to enable operators to access the related data quickly and easily.

A Plurality of Scenes with a Plurality of Viewpoints

When there are a plurality of video capture devices with non-overlapping areas of coverage (i.e., diverse scenes for at least some of the video data inputs), it can be difficult with current methods to determine which video inputs are useful for tracking a target object as it leaves a scene. In some cases with a limited number of video inputs human operators can learn which video inputs to switch to, but in cases with a large number of video inputs, such as a city with thousands of cameras, or when using archived footage that may have come in part from contributed video shot from camera phones or other video capture devices not previously known to operators, selecting the best video to gain the views needed is difficult if not impossible. In real-time scenarios there may not be time for a trial-and-error approach of switching views until one is found with the needed coverage, and the problem becomes worse when the factor of some, but not all, video capture device views being controllable is added. Operators not only have to know where cameras are located, but also what the extent of their view options are in terms of pan and tilt as well as zoom, and what objects will be occluding what portions of their coverage. Delays and mistakes can result in important video data not being captured.

Having a database containing video capture device locations, coverage areas, capabilities, and the objects in those coverage areas enables rapid selection of the video capture device with the best view of any given location. Being able to detect and identify objects in real-time that are in view of each video capture device enables tracking of a given object between scenes, even when there are gaps in coverage. As the object leaves one scene it may enter another, but if there is a gap between scenes, any surrounding scenes will pick up the object as it enters one of them, and operators can be alerted, or their monitors switched to the scene with the object. If the object does not enter another scene, the possible area in which it is located will be known to a precision dependent on the density of scene coverage, which reduces the area needed for searching. Based on historical data it can be possible to predict with some probability of being correct, which scene an object will enter after leaving a previous scene. Such predictions can aid in re-pointing video capture devices ahead of time, alerting operators, and/or assigning video feeds to monitors. Use of predictions in such ways can be based at least in part on the confidence level assigned to the predictions.

The database of video capture device scene coverage capabilities is also useful for determining which video capture devices can be re-pointed to provide additional views of a given scene. For example, the field of view of a first video capture device might be limited to a section of a parking lot. If an event of interest, such as a car leaving that section, occurs, the car will be lost from view when it leaves the section covered by the first video capture device. There may be no other video capture devices covering the area the car has moved into, but if a second video capture device can be commanded to re-point so as to view the area the car has moved into, tracking can continue. Determination of a second video capture device capable of viewing the required area is enabled by the database, both in terms of locating the car and its direction and speed of movement from metadata extracted or derived from previously input VDUs, as well as determining which alternate video capture device to use for the second video input.

In some scenarios there can be a conflict between the need to have a given video capture device capture a first scene or a second scene. For example, a given video capture device can be needed to capture a scene where a security alarm has been activated at the same time that it is needed to capture a scene of a riot. If the two scenes do not overlap, there is a conflict, and a decision is needed as to which of the two scenes will be captured. In embodiments where such scene capture requirements are initiated as responses to events, the event processing system can be designed to incorporate a priority scheme, where each event has an associated unique priority, and the event with the highest priority decides which scene is captured. When no events are active, the video capture device's default scene capture behavior is carried out. In alternative embodiments other methods can be used, such as the video capture device responding to the most recent scene capture request, or a human operator being requested to decide which scene to capture.

When working with video of a scene from a plurality of video capture devices with non-overlapping scene coverage, the creation of a cleared background for use in a user interface as described herein for working with a single video capture device input can be impossible. With a plurality of non-overlapping scenes, a single cleared background of the sort described above is not possible. In cases involving a plurality of non-overlapping scenes, a matrix of views can be presented, each one comprising a single scene (possibly with a plurality of video inputs from various video capture devices that cover some or all of the scene). Alternatively, a synthesized view can be created that includes the scene coverage areas of one or more scenes, and the selected objects located appropriately within it. Such a synthesized view can appear as a map, as a 3D computer-generated virtual world, or other representation as determined to be useful by those with skill in the art. Another alternative is display of object metadata in graphical form, such as bar charts, scatter plots, or other well understood representations of data. Yet another alternative is use of combinations of these methods, such as a map showing scene coverage, with icons representing objects located on it in positions related to their actual locations, overlaid with metadata graphic plots showing such information as object speed, time of video capture, etc. Events, such as object interactions, can be highlighted. Other alternative displays of object metadata, such as display of object locations with variations in appearance related to confidence values for derived location metadata, are possible.

### Other Capabilities

When tracking specific objects through or between scenes, such as for intelligence or law enforcement purposes, it can be useful to know what other objects an object of interest has interacted with. A system capable of identifying and following a given object through a scene or through a plurality of scenes, and that can automatically identify activities (e.g., stopping, beginning movement, joining with another object, separating from another object, etc.), is capable of automatically detecting at least some interactions between objects. This enables creation of a relationship network between objects, and can result in identification of additional objects of interest. Whether an interaction between objects results in creation of a new object of interest can be determined by human operators who are shown the interaction and queried, or be handled automatically through, for example, a rule-based system that defines the types of interactions, duration of interaction, frequency of interaction, etc., required to create a new object of interest. Determination of interaction between objects can be probabilistic and involve confidence values in some exemplary embodiments. In some such exemplary embodiments, the duration of interaction, the number of interactions, or the frequency of interactions can be factors in determining the confidence value that an interaction has occurred, or that a second object interacting with a first object that is of interest should also become of interest.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, those skilled in the art will recognize that its usefulness is not limited thereto and that the present invention can be beneficially utilized in any number of environments and implementations where it is desirable to capture large quantities of video, automatically log the characteristics and content of the video, and flexibly and selectively retrieve video to be displayed in various original and modified forms. Accordingly, the claims set forth below should be construed in view of the full breadth and spirit of the invention as disclosed herein.

What is claimed:

1. A method of displaying video objects, comprising:
using a computer processor to identify a set of objects in a video sequence, the identifying distinguishing between background objects and non-background objects;
the computer processor creating a cleared background video or still image format representation of a video scene background that does not contain non-background objects by removing non-background objects from the video sequence; providing a selection list of the non-background objects filtered based upon at least a first filtering criteria including one or more of time, type, location, color, and motion;
the computer processor obtaining a selection of one or more items from the list of non-background objects; and
the computer processor causing display of video, iconic, or graphic representations of the selected one or more non-background objects superimposed over the cleared background video or image.

2. The method of claim 1 further including the computer processor causing display of non-background objects in the list using icons associated with the non-background objects.

3. The method of claim 1 further including the computer processor applying and displaying filtering criteria to select each object.

4. The method of claim 1 further including the computer processor displaying attributes of at least some of the non-background objects.

5. The method of claim 4 wherein the displayed attributes include one or more of type, speed, time span, movement, and action

6. The method of claim 1 where the display of non-background objects is in relative real-time mode.

7. The method of claim 1 where the display of non-background objects is in overlapped-time mode.

8. A method for creating or enhancing metadata for a first video sequence using metadata from a second video sequence comprising:
at least one camera configured to capture the first video sequence and associated first metadata and to capture a second video sequence and associated second metadata; and
a processor connected to receive the captured first and second video sequences, the processor being configured to determine whether the first and second video sequences are to be correlated, and to modify the first metadata based at least in part on the second metadata.

9. The method of claim 8 further including maintaining links between metadata enhanced by use of other metadata, and that other metadata, for use in propagating changes resulting from update of metadata in future.

10. The method of claim 8 further including adjusting confidence values with changes in metadata.

11. The method of claim 8 further including contagious tracking of objects.

12. A system for analyzing and displaying video objects, comprising:
a device that provides a video sequence;
a computer processor coupled to the device, the computer processor being configured to identify a set of objects in the video sequence including distinguishing between background objects and non-background objects;
the computer processor being further configured to create a cleared background video or still image format representation of a video scene background that does not contain non-background objects by removing non-background objects from the video sequence; providing a selection list of the non-background objects filtered based upon at least a first filtering criteria including one or more of time, type, location, color, and motion;
the computer processor being further configured to obtain a selection of one or more items from the list of non-background objects;
the computer processor being further configured to generate a display of video, iconic, or graphic representations of the selected one or more non-background objects superimposed over the cleared background video or image.

13. The system of claim 12 wherein the computer processor is further configure to cause display of non-background objects in the list using icons associated with the non-background objects.

14. The system of claim 12 wherein the computer processor is configured to apply and display filtering criteria to select each object.

15. The system of claim 12 wherein the computer processor is further configured to display attributes of at least some of the non-background objects.

16. The system of claim 15 wherein the displayed attributes include one or more of type, speed, time span, movement, and action

17. The system of claim 15 where the display of non-background objects is in relative real-time mode.

18. The system of claim 12 where the display of non-background objects is in overlapped-time mode.
